(19) United States
(12) Patent Application Publication
(10) Pub. No.: US 2020/0049477 A1
(43) Pub. Date: Feb. 13, 2020

(54) PORTABLE COLLABORATIVE ROBOTIC ARTICULATED ARM COORDINATE MEASURING MACHINE

(71) Applicant: FARO Technologies, Inc., Lake Mary, FL (US)

(72) Inventors: Kishore Lankalapalli, Sanford, FL (US); John Lucas Creachbaum, Deltona, FL (US); Yue Li, Lake Mary, FL (US); Dragos M. Stanescu, Lake Mary, FL (US)

(21) Appl. No.: 16/660,148

(22) Filed: Oct. 22, 2019

Related U.S. Application Data
(63) Continuation-in-part of application No. 16/400,635, filed on May 1, 2019.
Application No. 16/400,635 is a continuation-in-part of application No. 16/364,474, filed on Mar. 26, 2019.
(60) Provisional application No. 62/816,457, filed on Mar. 11, 2019.
(60) Provisional application No. 62/816,457, filed on Mar. 11, 2019.
(60) Provisional application No. 62/714,861, filed on Aug. 6, 2018.
(60) Provisional application No. 62/666,969, filed on May 4, 2018.
(60) Provisional application No. 62/656,477, filed on Apr. 12, 2018.
(60) Provisional application No. 62/714,861, filed on Aug. 6, 2018.
(60) Provisional application No. 62/656,477, filed on Apr. 12, 2018.

(51) Int. Cl. G01B 5/008; G01B 11/00; B25J 15/00; B25J 9/12; B25J 19/00

(52) U.S. Cl. CPC G01B 5/008; G01B 11/005; B25J 19/0016; B25J 9/126; B25J 19/0012; B25J 15/0019

(57) ABSTRACT

A motorized articulated arm coordinate measuring machine (AACMM) includes a base, a plurality of motorized arm segments, a measurement probe, and an electronic circuit for directing movement of the measurement probe to obtain three-dimensional (3D) coordinates of points on an object. At least one of the motorized arm segments includes a motorized cartridge.

### CROSS REFERENCE TO RELATED APPLICATIONS

This application claims the benefit of U.S. Provisional Application Ser. No. 62/816,457 filed Mar. 11, 2019, and is a Continuation-in-Part of U.S. application Ser. No. 16/400,635 filed May 1, 2019, which is a Continuation-in-Part of U.S. application Ser. No. 16/364,474 filed Mar. 26, 2019, and which claims priority to U.S. Provisional Application Ser. No. 62/816,457 filed Mar. 11, 2019, U.S. Provisional Application Ser. No. 62/714,861 filed Aug. 6, 2018, U.S. Provisional Application Ser. No. 62/666,969 filed May 4, 2018, and U.S. Provisional Application Ser. No. 62/656,477 filed Apr. 12, 2018. U.S. application Ser. No. 16/364,474 filed Mar. 26, 2019, further claims priority to U.S. Provisional Application Ser. No. 62/714,861 filed Aug. 6, 2018, and U.S. Provisional Application Ser. No. 62/656,477 filed Apr. 12, 2018. The contents of all of these applications are incorporated herein by reference in their entireties.

### BACKGROUND

The present disclosure relates to coordinate measuring systems, and especially to a robotic articulated arm coordinate measuring machine (AACMM) designed to be safe for and responsive to operation by human operators.

Portable articulated arm coordinate measuring machines (AACMMs) have found widespread use in the manufacturing or production of parts where there is a desire to rapidly and accurately verify the dimensions of the part during various stages of the manufacturing or production (e.g., machining) of the part. Portable AACMMs represent a vast improvement over known stationary or fixed, cost-intensive and relatively difficult to use measurement installations, particularly in the amount of time it takes to perform dimensional measurements of relatively complex parts. Typically, a user of a portable AACMM simply guides a probe along the surface of the part or object to be measured. The measurement data are then recorded and provided to the user. In some cases, the data are provided to the user in visual form, for example, three-dimensional (3D) form on a computer screen. In other cases, the data are provided to the user in numeric form, for example when measuring the diameter of a hole, the text “Diameter=1.0034” is displayed on a computer screen.

Today, there is a desire for a robotic measuring device having the relatively high accuracy of an AACMM. Such accuracy is generally much better than that available from robots used in manufacturing. There is also a desire for a robotic measuring device that may be safely operated in the presence of humans and that may further be trained by humans or used by humans in a manual operation mode. The desired AACMM should have a size and cost not much greater than a conventional AACMM. No such robotic AACMM meeting all these criteria is currently available.

Accordingly, while existing AACMM's are suitable for their intended purposes, there remains a need for a collaborative robotic AACMM having relatively high accuracy in a portable package.

### BRIEF DESCRIPTION

According to one aspect of the disclosure, a motorized articulated arm coordinate measuring machine (AACMM) comprises: a base; an arm portion having opposed first and second ends, the arm portion being rotationally coupled to the base, the arm portion including a plurality of connected arm segments, each arm segment including at least one position transducer for producing a position signal, each arm segment further including a motorized assembly operable to rotate about an axis, the motorized assembly being either a motorized cartridge or an extended motorized assembly; a measurement probe coupled to the first end; and an electronic circuit operable to receive the position signal from the at least one position transducer and provide data corresponding to a position of the measurement probe, the electronic circuit further operable to direct movement the measurement probe.

In addition to one or more of the features described herein, or as an alternative, further embodiments of the AACMM may include at least one motorized assembly that has a motor having a stator and a rotor. In addition to one or more of the features described herein, or as an alternative, further embodiments of the AACMM may include the at least one motorized assembly further having an elastic element. In addition to one or more of the features described herein, or as an alternative, further embodiments of the AACMM may include the at least one motorized assembly further having a gear assembly.

In addition to one or more of the features described herein, or as an alternative, further embodiments of the at least one motorized assembly further includes a first rotary encoder operable to measure first angles and a second rotary encoder operable to measure second angles. In addition to one or more of the features described herein, or as an alternative, further embodiments of the at least one motorized assembly further includes a first pair of bearings and a second pair of bearings. In addition to one or more of the features described herein, or as an alternative, further embodiments of the at least one motorized assembly is affixed to one of the plurality of connected arm segments, the at least one motorized cartridge causing either a swivel rotation or a hinge rotation of the arm segment.

In addition to one or more of the features described herein, or as an alternative, further embodiments of the AACMM may include a motion of the one of the plurality of connected arm segments being determined at least in part by a control system that adjusts the motor motion based at least in part on the first angles measured by the first rotary encoder and the second angles measured by the second rotary encoder. In addition to one or more of the features described herein, or as an alternative, further embodiments of the AACMM may include the second angles being angles of rotation of the elastic element, the elastic element being driven by the gear assembly. In addition to one or more of the features described herein, or as an alternative, further embodiments of the AACMM may include a motion of the arm segments is responsive to force applied to the arm segments.

In addition to one or more of the features described herein, or as an alternative, further embodiments of the AACMM may include a first mode where an operator may manually move the arm segments to desired positions. In addition to one or more of the features described herein, or as an alternative, further embodiments of the AACMM may include the arm segments remaining stationary in their current positions in absence of the force applied by the operator or a command given by a processor to the control system. In addition to one or more of the features described herein, or as an alternative, further embodiments of the AACMM may include in a mode of operation of the motorized AACMM, the operator trains the motorized AACMM to move the arm segments in a prescribed path by moving the arm segments in the prescribed path.

In addition to one or more of the features described herein, or as an alternative, further embodiments of the AACMM may include, in response to an instruction given by the processor, the motorized AACMM moves the arm segments in the prescribed path and measures three-dimensional (3D) coordinates of a point on an object. In addition to one or more of the features described herein, or as an alternative, further embodiments of the AACMM may include the AACMM further measures three-dimensional (3D) coordinates of the point on an object in response to a command given by the processor. In addition to one or more of the features described herein, or as an alternative, further embodiments of the AACMM may include the measurement probe is selected from a group consisting of hard-probe, a touch-trigger probe, and a scanning probe.

In addition to one or more of the features described herein, or as an alternative, further embodiments of the AACMM may include the measurement probe includes a line scanner. In addition to one or more of the features described herein, or as an alternative, further embodiments of the AACMM may include the measurement probe includes a stereo camera. In addition to one or more of the features described herein, or as an alternative, further embodiments of the AACMM may include the measurement probe includes a distance meter.

In addition to one or more of the features described herein, or as an alternative, further embodiments of the AACMM may the line scanner includes a high dynamic range (HDR) mode. In addition to one or more of the features described herein, or as an alternative, further embodiments of the AACMM may include the line scanner measures object color as well as three-dimensional (3D) coordinates. In addition to one or more of the features described herein, or as an alternative, further embodiments of the AACMM may include the measurement probe is a structured light scanner.

In addition to one or more of the features described herein, or as an alternative, further embodiments of the AACMM may include the control system stops movement of the arm segments in response to the force that exceeds a specified desired limit. In addition to one or more of the features described herein, or as an alternative, further embodiments of the AACMM may include the motorized assembly is the motorized cartridge, the motorized cartridge being affixed within a receptacle, the receptacle being coupled to the one of the plurality of connected arm segments. In addition to one or more of the features described herein, or as an alternative, further embodiments of the AACMM may include each of the plurality of connected arm segments being driven in a swivel rotation or a hinge rotation by the motorized cartridge or the extended motorized assembly, each motorized cartridge or motorized assembly including a motor, a rotary encoder, and a pair of bearings.

In addition to one or more of the features described herein, or as an alternative, further embodiments of the AACMM may include the at least one motorized cartridge being coupled to a counterbalance spring. In addition to one or more of the features described herein, or as an alternative, further embodiments of the AACMM may include the action of at least one motorized cartridge receives a counterbalancing torque from a counterbalancing element selected from a group consisting of: a hydraulic cylinder and a counterbalancing weight. In addition to one or more of the features described herein, or as an alternative, further embodiments of the AACMM may include the motorized assembly being the extended motorized assembly, the extended motorized assembly further including one of the arm segments.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features and advantages of the invention are apparent from the following detailed description taken in conjunction with the accompanying drawings in which:

FIGS. 1A, 1B are isometric views of a portable AACMM;

FIG. 1C is an isometric view of a portable robotic AACMM according to an embodiment of the present disclosure;

FIGS. 2A, 2B are isometric and exploded views, respectively, of a third-axis assembly and a fourth-axis assembly of an AACMM;

FIG. 2C is an isometric view of a third-axis assembly and a fourth-axis assembly of a robotic AACMM according to an embodiment of the present disclosure;

FIG. 3 is a motorized cartridge assembly used to convert the third-axis swivel joint of a traditional AACMM into a motorized swivel joint of a robotic AACMM according to an embodiment of the present disclosure;

FIG. 4A is a motorized cartridge assembly used to convert the fourth-axis hinge joint of a traditional AACMM into a motorized hinge joint of a robotic AACMM according to an embodiment of the present disclosure;

FIG. 4B is an isometric view of a fifth-axis assembly, a second segment, and a sixth-axis assembly according to an embodiment of the present disclosure;

FIG. 4C is a partially cut-away view showing a method of joining the fourth-axis assembly to the fifth-axis assembly according to an embodiment of the present disclosure;

FIG. 5 is an isometric view illustrating some elements in a lower portion of the AACMM;

FIGS. 6A, 6B are cross-sectional and isometric views of motorized cartridge assembly used to convert the first-axis swivel joint into a robotic swivel joint according to an embodiment of the present disclosure;

FIG. 7A is an isometric cross-sectional view of a motorized second axis/counterbalance assembly according to an embodiment of the present disclosure;

FIG. 7B is a yoke assembly that connects the motorized cartridge assembly of the first axis to the motorized rotary assembly of the second axis according to an embodiment of the present disclosure;

FIG. 8A is a partially exploded cross-sectional illustration of a drive assembly of a motorized rotary assembly in accordance with an embodiment of the present disclosure;

FIG. 8B is a partially exploded cross-sectional illustration of an output subassembly of the drive assembly of FIG. 8A according to an embodiment of the present disclosure;

FIG. 8C is a partially exploded schematic illustration of a motor subassembly of the drive assembly of FIG. 8A according to an embodiment of the present disclosure;

FIG. 9A is a schematic illustration of an output shaft in accordance with an embodiment of the present disclosure;

FIG. 9B is a schematic illustration of an elastic element that may be incorporated into embodiments of the present disclosure;

FIG. 10A is a block diagram of a control system according to an embodiment of the present disclosure;

FIG. 10B is an isometric cross-sectional view of a swivel extension element according to an embodiment of the present disclosure;

FIGS. 10C, 10D are isometric cross-sectional views of left and right portions, respectively, of the swivel extension element of FIG. 10B according to an embodiment of the present disclosure;

FIG. 10E is a cross sectional view of a motorized swivel cartridge according to an embodiment of the present disclosure;

FIG. 10F is an exploded cross-sectional view of the motorized swivel cartridge according to an embodiment of the present disclosure;

FIGS. 10G, 10H, 10J are front, side, and isometric views of an output subassembly according to an embodiment of the present disclosure;

FIG. 10K is a front view of an elastic flexure according to an embodiment of the present disclosure;

FIGS. 11A, 11B are isometric and side views of a seventh-axis assembly, tactile-probe assembly, and handle according to an embodiment of the present disclosure;

FIGS. 12A, 12B are isometric views of a seventh-axis assembly and tactile-probe assembly according to an embodiment of the present disclosure;

FIG. 12C is an isometric view of a touch-trigger probe according to an embodiment of the present disclosure;

FIG. 12D is a front view of a scanning probe according to an embodiment of the present disclosure;

FIG. 13A is a laser line probe according to an embodiment of the present disclosure;

FIG. 13B is an accessory having stereo camera, structured light scanner, and line scanner capability as well as a built-in display according to an embodiment of the present disclosure;

FIGS. 14A, 14B, 14C are isometric, top, and side views, respectively, of an end-effector assembly according to an embodiment of the present disclosure;

FIG. 15A is an isometric view of a robotic AACMM having hydraulic cylinders operable to provide a counterbalancing force to gravity according to an embodiment of the present disclosure; and

FIG. 15B is an isometric view of a robotic AACMM having a counterbalancing weight operable to provide a counterbalancing force to gravity according to an embodiment of the present disclosure.

The detailed description explains embodiments of the invention, together with advantages and features, by way of example with reference to the drawings.

### DETAILED DESCRIPTION

In embodiments of the present disclosure, a robotic AACMM is not much larger or costlier than a traditional AACMM yet provides advantages in enabling fully automated measurements as well as user assisted measurements.

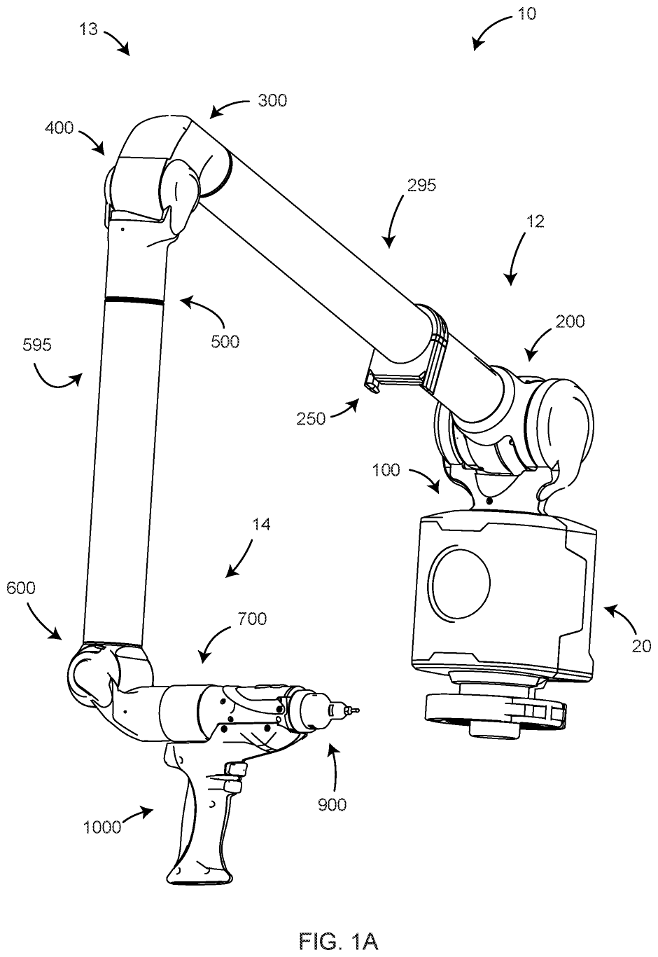

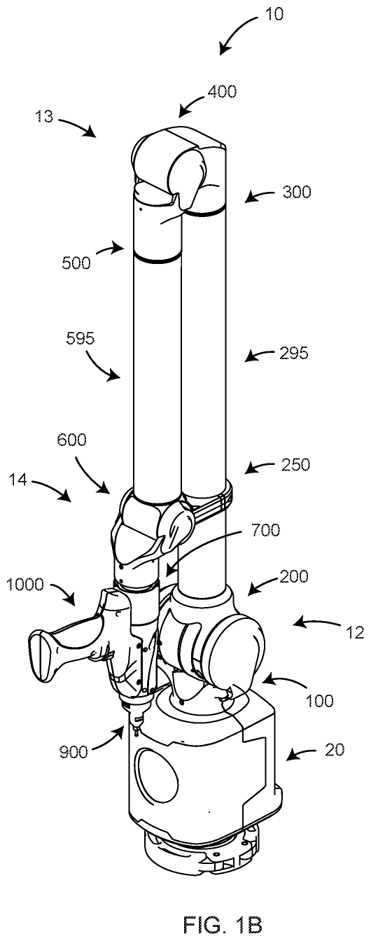

FIGS. 1A, 1B illustrate, in isometric view, a traditional AACMM 10. A first arm segment 295 and a second arm segment 595 are connected to a base 20 on one end and a measurement device on the other end. The illustrated measurement device is a tactile-probe assembly 900.

In an embodiment illustrated in FIGS. 1A, 1B, the AACMM 10 includes seven rotational elements; hence the AACMM 10 is referred to as a seven-axis AACMM. In other embodiments discussed herein below, the AACMM 10 is a six-axis AACMM. The seven-axis AACMM 10 of FIGS. 1A, 1B includes first-axis assembly 100, second-axis assembly 200, third-axis assembly 300, fourth-axis assembly 400, fifth-axis assembly 500, sixth-axis assembly 600, and seventh-axis assembly 700. In an embodiment, a tactile-probe assembly 900 and a handle 1000 are attached to the seventh-axis assembly. Each of the axis assemblies may provide either a swivel rotation or a hinge rotation. In the embodiment illustrated in FIGS. 1A, 1B, the first-axis assembly 100 provides a swivel rotation about an axis aligned to a mounting direction of the base 20. In an embodiment, the second-axis assembly 200 provides a hinge rotation about an axis perpendicular to the first arm segment 295. The combination of the first-axis assembly 100 and the second-axis assembly 200 is sometimes colloquially referred to as a shoulder 12 since in some embodiments the possible motions of the shoulder 12 of the AACMM 10 resemble the motions possible with a human shoulder.

In the embodiment illustrated in FIGS. 1A, 1B, the third-axis assembly 300 provides a swivel rotation about an axis aligned to the first arm segment 295. The fourth-axis assembly 400 provides a hinge rotation about an axis perpendicular to second arm segment 595. The fifth-axis assembly 500 provides a swivel rotation about an axis aligned to the second arm segment 595. The combination of the third-axis assembly 300, the fourth-axis assembly 400, and the fifth-axis assembly 500 is sometimes colloquially referred to as an elbow 13 since in some embodiments the possible motions of the elbow 13 of the AACMM 10 resemble the motions possible with a human elbow.

In the embodiment illustrated in FIGS. 1A, 1B, the sixth-axis assembly 600 provides a hinge rotation about an axis perpendicular to the second arm segment 595. In an embodiment, the AACMM 10 further comprises a seventh-axis assembly 700, which provides a swivel rotation of probe assemblies (e.g., tactile-probe assembly 900) attached to the seventh-axis assembly 700. The sixth-axis assembly 600, or the combination of the sixth-axis assembly 600 and the seventh-axis assembly 700, is sometimes colloquially referred to as a wrist 14 of the AACMM 10. The wrist 14 is so named because in some embodiments it provides motions like those possible with a human wrist. The combination of the shoulder 12, first arm segment 295, elbow 13, second arm segment 595, and wrist 14 resembles in many ways a human arm from human shoulder to human wrist. In some embodiments, the number of axis assemblies associated with each of the shoulder, elbow, and wrist differ from the number shown in FIGS. 1A, 1B. It is possible, for example, to move the third-axis assembly 300 from the elbow 13 to the shoulder 12, thereby increasing the number of axis assemblies in the shoulder to three and reducing the number of axis assemblies in the wrist to two. Other axis combinations are also possible.

In FIGS. 1A, 1B, a parking clamp 250 is used to hold the first arm segment 295 and the second arm segment 595 in a vertical orientation, thereby minimizing the space taken by the arm segments 295, 595 when the AACMM 10 is not in use performing a measurement.

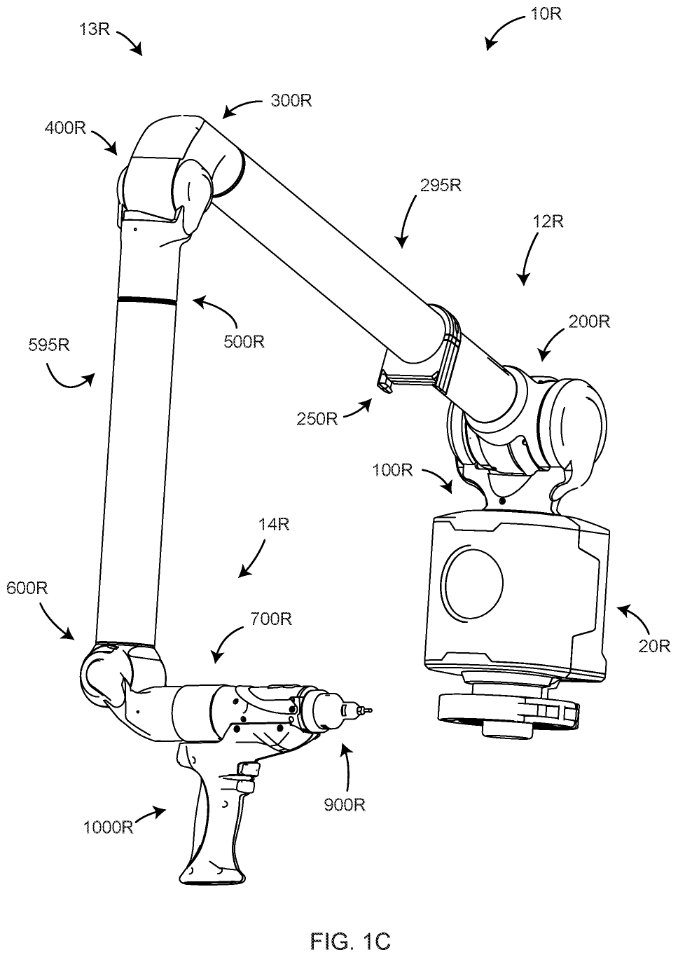

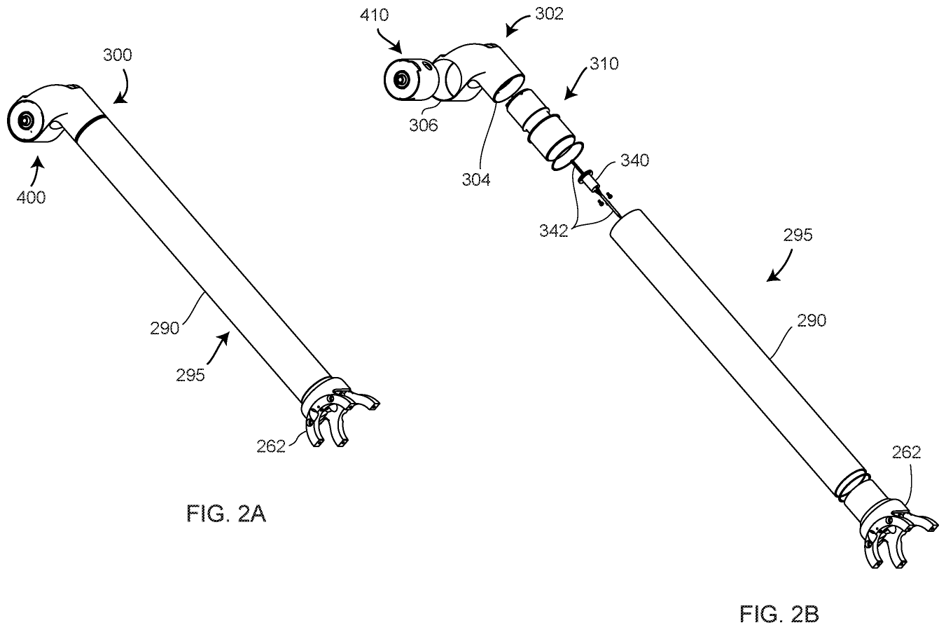

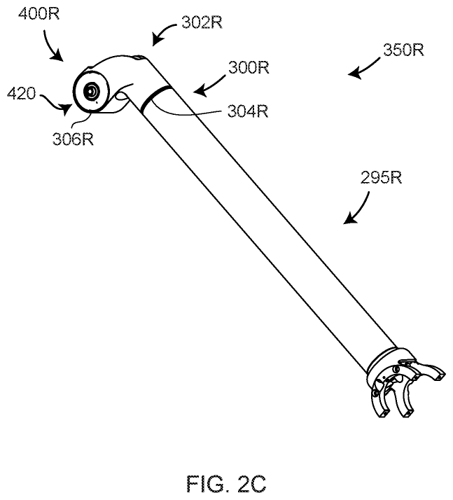

FIG. 1C is an isometric view of a robotic AACMM. In an embodiment of the present disclosure, the robotic arm 10R has an identical appearance to the traditional robotic arm 10R, but the robotic AACMM includes additional motorized components internal to the AACMM structure. In other embodiments, components of the robotic AACMM 10R are somewhat larger than the components of the AACMM 10 to accommodate motorized elements. The elements 10R, 12R, 13R, 14R, 20R, 100R, 200R, 250R, 295R, 300R, 400R, 500R, 595R, 600R, 700R, 900R, 1000R in FIG. 2C correspond, respectively, to the elements 10, 12, 13, 14, 20, 100, 200, 250, 295, 300, 400, 500, 595, 600, 700, 900, 1000 in FIGS. 2A, 2B.

As explained herein above, in a traditional manual AACMM, the third-axis assembly 300 provides a swivel rotation about an axis aligned to the first arm segment 295, while the fourth-axis assembly 400 provides a hinge rotation about an axis perpendicular to second arm segment 595. FIGS. 2A, 2B are isometric and exploded views, respectively, of the first arm segment 295, the third-axis assembly 300, and the fourth-axis assembly 400. The third-axis assembly includes a cartridge adapter 302 having receptacles 304, 306 sized to accept the cartridges 310, 410, respectively. The cartridge adapter 302 is common to the third-axis assembly 300 and the fourth-axis assembly 400. The cables 342 pass through the slip ring 340.

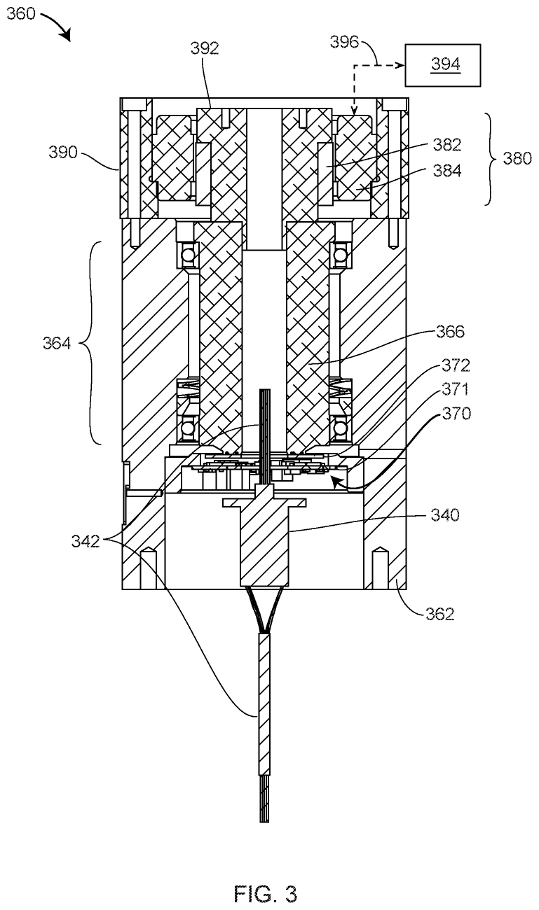

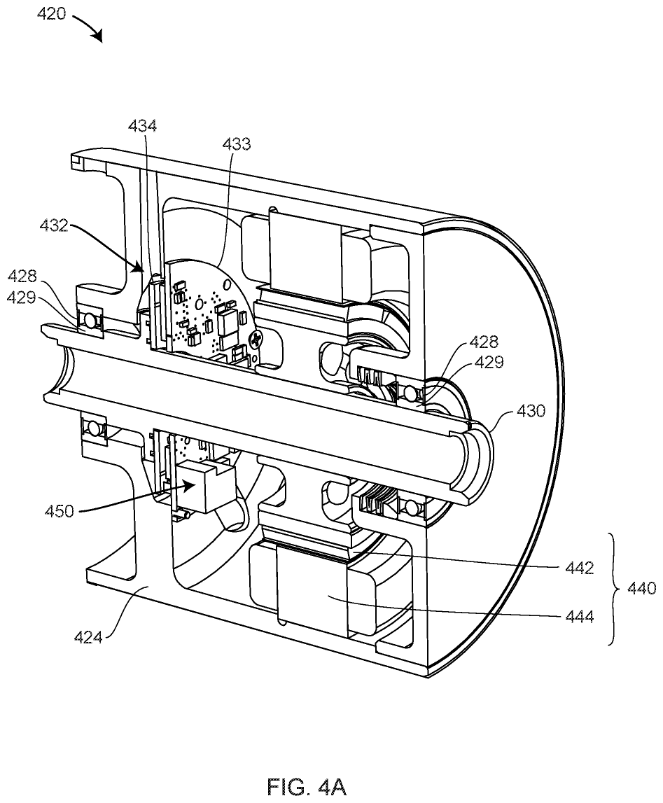

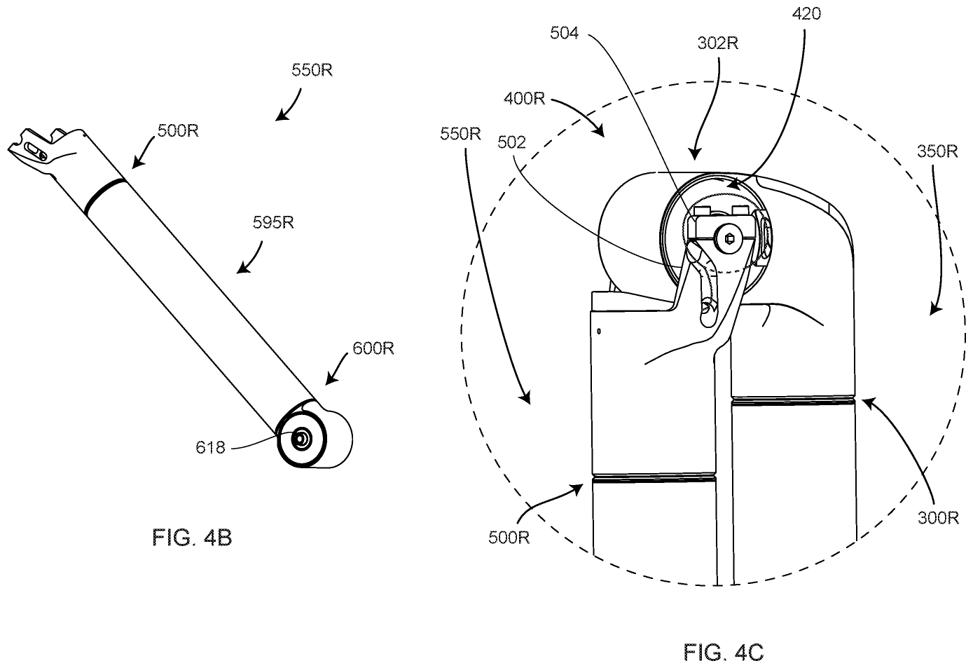

FIG. 2C is an isometric view of the third-fourth axis assembly 350R comprising first arm segment 295R, the third-axis assembly 300R, and the fourth-axis assembly 400R for a robotic AACMM 10R. The third-axis assembly 300R includes a cartridge adapter 302R having receptacles 304R, 306R sized to accept cartridges 360 (FIG. 3), 420 (FIG. 4A), respectively. The cartridge adapter 302R is common to the third-axis assembly 300R and the fourth-axis assembly 400R.

FIG. 3 is a cross-sectional view of a motorized cartridge 360. In an embodiment, the motorized cartridge 360 fits in the receptacle 306R in the cartridge adapter 302R. The motorized cartridge 360 includes a cartridge housing 362, a bearing assembly 364 and a shaft 366 that is rotatable within the cartridge housing 362. The cartridge housing 362 is stationary within the receptacle 306R. In an embodiment, a position transducer assembly 370 is arranged within the cartridge housing 362 and includes at least one component attached or connected to the shaft 366 and at least one component separate from the shaft 366. In an embodiment, the position transducer assembly 370 includes a rotary encoder that measures the angle of rotation of the shaft 366. In an embodiment, the rotary encoder includes a read-head board 371 and an optical disk 372 having marks. In some embodiments, the position transducer assembly 370 is external, rather than internal, to the cartridge housing 362.

In an embodiment, a motor 380 includes a stator 384 and a rotor 382. In an embodiment, the stator 384 includes windings that receive a current to create a magnetic field, which interact with permanent magnets of the rotor 382 to cause the rotor 382 to rotate. A rotor-and-stator subcomponent set is referred to as a frameless motor. Such a rotor-and-stator subcomponent set is integrated into the motorized cartridge 360 as shown in FIG. 3. In an embodiment, the stator 384 is fixedly attached to a motor housing 390, which is fixedly attached to the cartridge housing 362. In an embodiment, the rotor 382 is fixedly attached to an adapter 392, which is fixedly attached to the shaft 366. The cartridge 360 shown in FIG. 3 and the motorized cartridge 420 shown in FIG. 4 do not include a mechanical transmission element such as a gearbox, belt, or pulley. A motor, such as the motor 380, that is directly connected to a load is referred to as a direct drive motor. Hence the motor 380 is a direct drive motor that integrates the rotor 382 and stator 384 subcomponents of a frameless motor. A servomotor is defined as a rotary actuator or a linear actuator that allows for precise control of angular or linear position, velocity, and acceleration. It consists of a suitable motor coupled to a sensor for position feedback. In an embodiment, a control unit 394 remote from the cartridge 360 adjusts electrical current into the motor 380 as a way of controlling rotation of the rotor 382. The control unit 394 receives signals from one or more sensors, which may include the position transducer assembly 370. The control unit 394 further includes electrical control and processing components that receive signals from a wired or wireless communication connection 396. Hence the presence of the control unit 394 makes the motor 380 a servo motor as well as a direct drive motor having a frameless rotor-and-stator subcomponent set.

As shown in FIG. 2B, the cartridge adapter 302 includes a receptacle 306 that holds a traditional cartridge 410. In an embodiment of the present disclosure, a motorized cartridge 420, shown in cross section in FIG. 4A, fits into the receptacle 306R. The motorized cartridge 420 provides motorized hinge-type rotation of the second arm segment 595R about an axis perpendicular to the second arm segment 595R. In the embodiment illustrated in FIG. 4A, the motorized cartridge 420 includes a housing 424 to which a pair of bearings 428 are affixed. A rotatable shaft 430 is affixed to the inner race 429 of the bearings 428. In an embodiment, a rotary encoder assembly 432 internal to the housing 424 includes at least one component attached to the rotatable shaft 430 and at least one component not affixed to the rotatable shaft 430. In an embodiment, the rotary encoder assembly 432 includes a read-head board 433 having at least one read head and an optical disk 434 having marks. In the embodiment of FIG. 4A, the optical disk 434 rotates with the rotatable shaft 430 while the read-head board 433 is fixed with respect to the housing 424. In some embodiments, the rotary encoder assembly 432 is external, rather than internal, to the housing 424.

The term “motorized cartridge” as used in the present document refers to an assembly the produces motorized motion of an external element such as an arm segment or a measurement probe. By this definition, a motorized cartridge is a localized structure distinct from its associated arm segment or measurement probe. The motorized cartridge and the associated arm segment or measurement probe may overlap in a limited region. For example, a portion of a cartridge may be inserted into the associated arm segment to produce a swivel rotation or a hinge rotation of the arm segment. Alternatively, a cartridge shaft may be attached to a yoke of the associated arm segment so that rotation of the cartridge shaft produces a hinge rotation of the associated arm segment attached to the shaft. Likewise, a portion of the cartridge may be attached to an associated measurement probe to produce a swivel or hinge rotation of the measurement probe. There may be some overlap of the cartridge with the measurement probe in the attachment region.

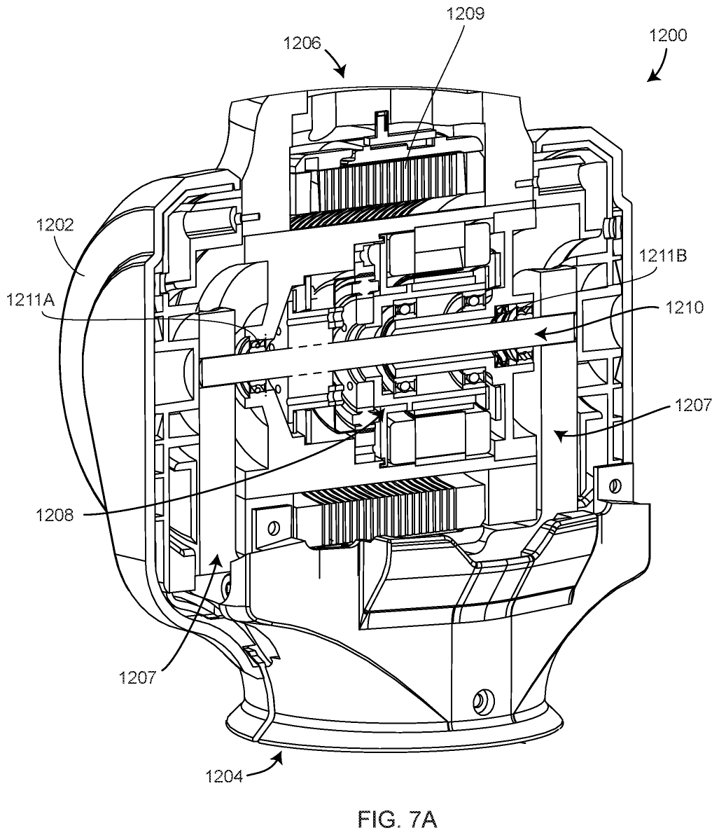

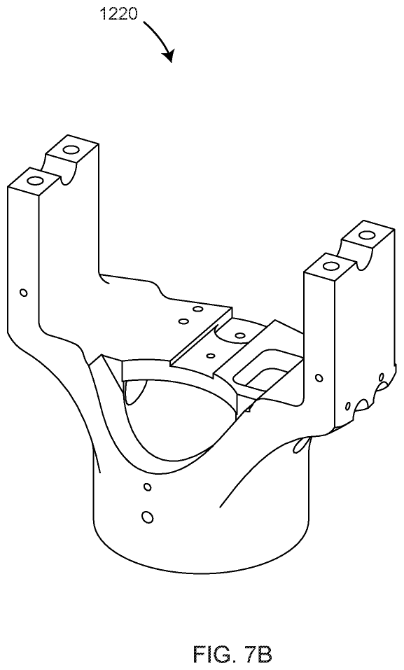

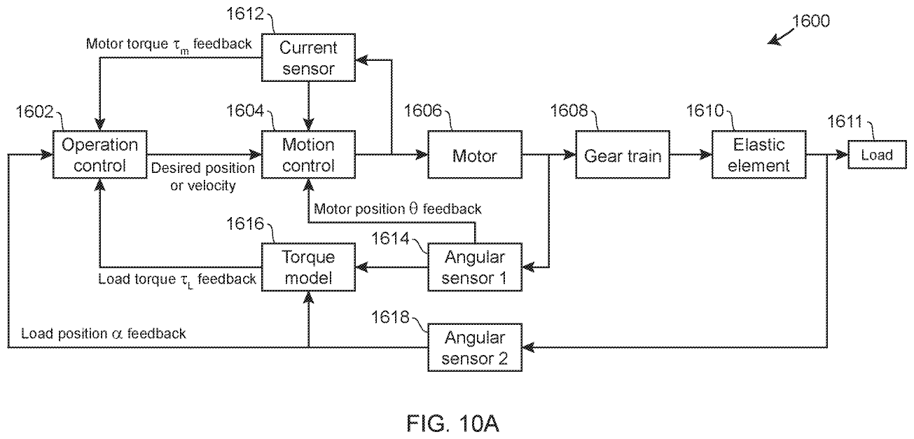

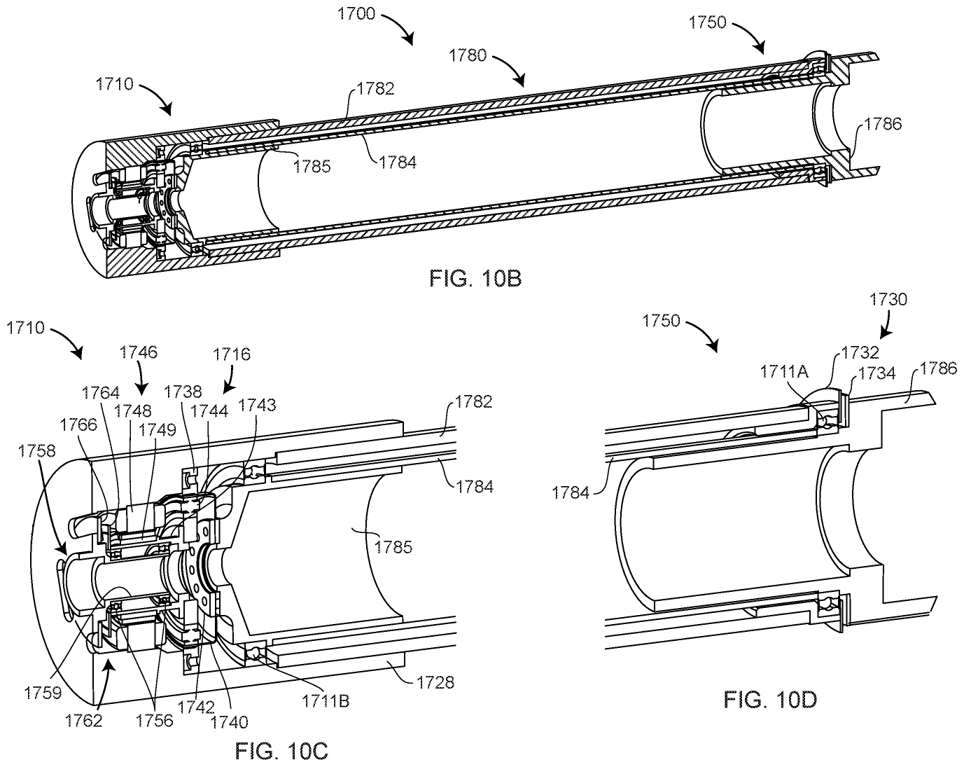

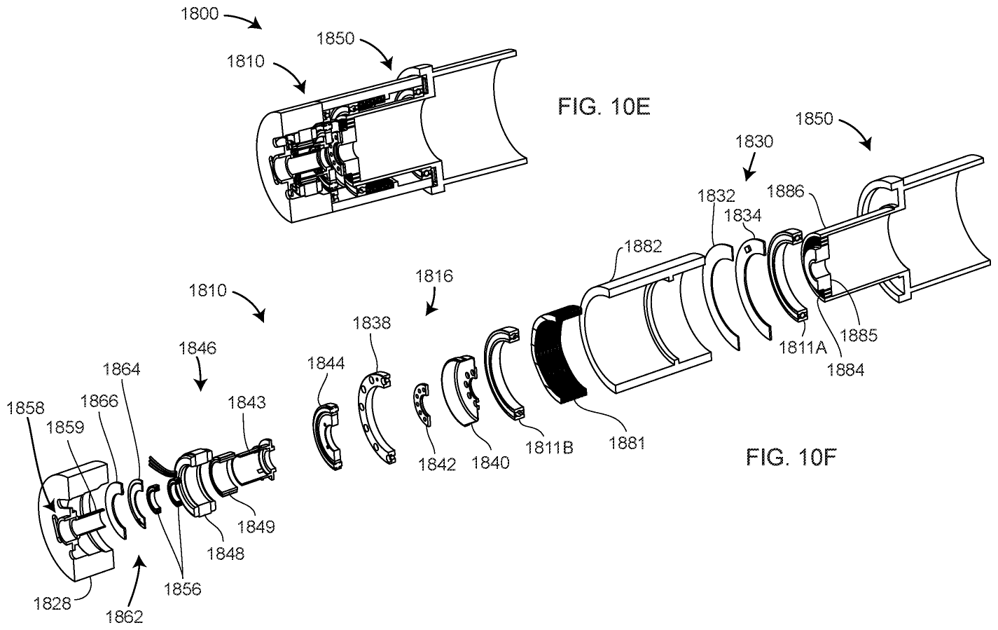

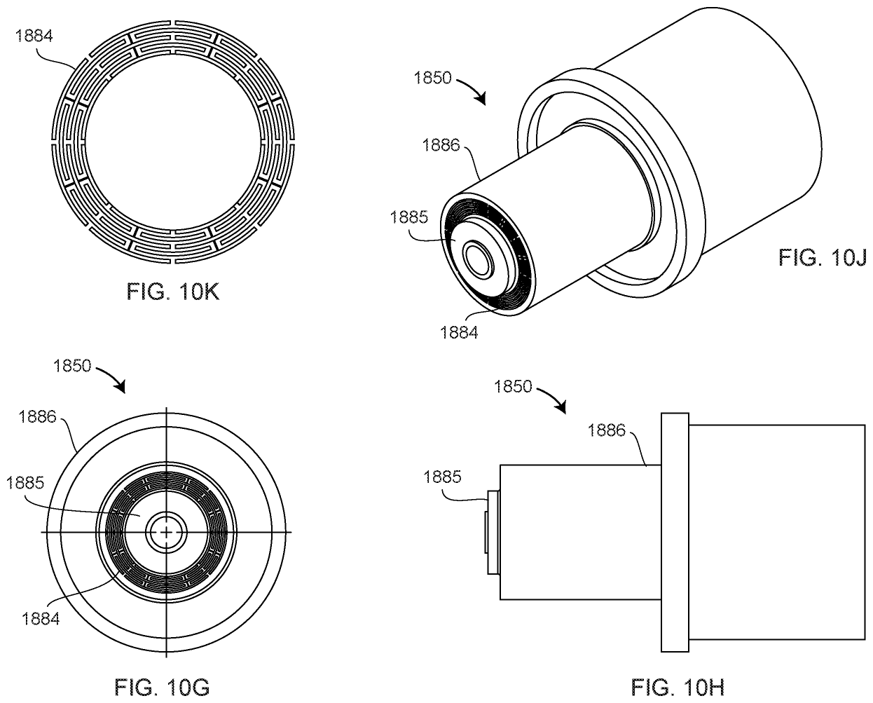

An alternative to a “motorized cartridge” is an “extended motorized assembly.” An example of a motorized cartridge is the motorized cartridge 1800 (FIGS. 10E, 10F, 10G, 10H, 10J, 10K), which is a localized structure that produces swivel motion. An example of an extended motorized assembly is the extended motorized swivel assembly 1700 (FIGS. 10B, 10C, 10D), which is an extended structure that produces swivel motion. The extended motorized swivel assembly 1700 includes an entire arm segment while the motorized cartridge 1800 is a localized structure. For example, an output subassembly 1850 at one end of the motorized cartridge 1800 may fit inside a hollow arm segment such as the arm segment 290, while the motor/gear subassembly 1810 at the other end of the motorized cartridge 1800 may fit inside a cartridge receptable such as the receptacle 304R. According to the definition of motorized cartridge given herein above, a motorized cartridge may include additional localized elements. For example, a spring may be placed around a cartridge to provide a force to partly counterbalance the pull of gravity of attached arm segments, as illustrated in the motorized second-axis assembly 1200 (FIG. 7A). In this case, the shaft, rotary encoders, bearings, motor, and gear assembly are all considered part of the cartridge. The spring may be considered a part of the cartridge if desired since, either with or without the spring, the motorized second-axis assembly 1200 is a localized structure.

Ordinarily, a cartridge includes a rotating shaft, a pair of bearings, and a position transducer. A motorized cartridge further includes a motor. The shaft, which may be hollow or solid, rotates relative to a cartridge housing. The pair of bearings enable low-friction rotation of the shaft within the cartridge housing. In most case, the position transducer includes a rotary encoder. In an embodiment, the rotary encoder includes an optical disk (usually glass) having marks and a read-head board having at least one read head. A light source sends light to the glass disk and a detector on the read head receives the light, which may be transmitted through the glass or reflected from the glass. One of the glass disk and the read-head board is fixedly attached to shaft, while the other of the glass disk and the read-head board is fixedly attached to the housing.

In an embodiment, a motor 440 includes a stator 444 and a rotor 442. In an embodiment, the stator 444 includes windings that receive a current to create a magnetic field, which interact with permanent magnets of the rotor 442 to cause the rotor 442 to rotate. The rotor-and-stator subcomponent set is integrated into the motorized cartridge 420 as shown in FIG. 4A. In an embodiment, the stator 444 is fixedly attached to the housing 424, while the rotor 442 is fixedly attached to the rotatable shaft 430. In an embodiment, a control unit 450 adjusts electrical current into the motor 440 as a way of controlling rotation of the rotor 442. As explained in the discussion of FIG. 3, the motor 440 is a servo motor as well as a direct drive motor having a frameless rotor-and-stator subcomponent set.

Although in the embodiment illustrated in FIG. 4A, the motor 440 does not include a mechanical transmission element such as a gearbox, belt, or pulley and hence is a direct-drive motor. However, in some embodiments, use of gears may be helpful for a hinge motion such as that provided by the second-axis assembly 200R, the fourth-axis assembly 400R, or the sixth-axis assembly 600R. Use of gearing methods for hinge rotation is discussed herein below in relation to the counterbalance mechanism of the second-axis assembly 200R, as illustrated in FIGS. 7A, 8A, 8B, 8C, 9, 10. In some embodiments, use of gear assemblies are also helpful for swivel motion such as that provided by the first-axis assembly 100R, the third-axis assembly 300R, the fifth-axis assembly 5008, or the seventh-axis assembly 700R. Use of gearing methods for swivel rotation is discussed herein below with reference to FIGS. 10B, 10C, 10D, 10E, 10F, 10G, 10H, 10J, 10K.

FIG. 4B is an isometric view of the combined fifth-sixth axis assembly 550R having the fifth-axis assembly 500R, the second arm segment 595R, and the sixth-axis assembly 600R. In an embodiment, the fifth-axis assembly 500R provides motorized swivel rotation using the motorized cartridge 360 shown in FIG. 3. In an embodiment, the sixth-axis assembly provides motorized hinge rotation using the motorized cartridge 420 shown in cross section in FIG. 4A.

FIG. 4C shows a method of coupling the third-fourth axis assembly 350R to the fifth-sixth axis assembly 550R. In an embodiment, a fifth-axis yoke 502 and a first-axis yoke cap 504 clamp to the rotatable shaft 430 of the motorized cartridge 420.

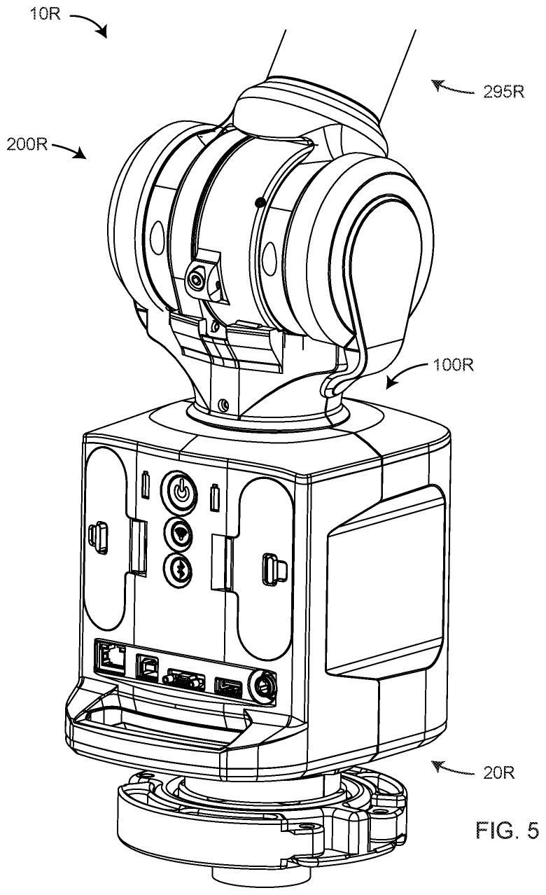

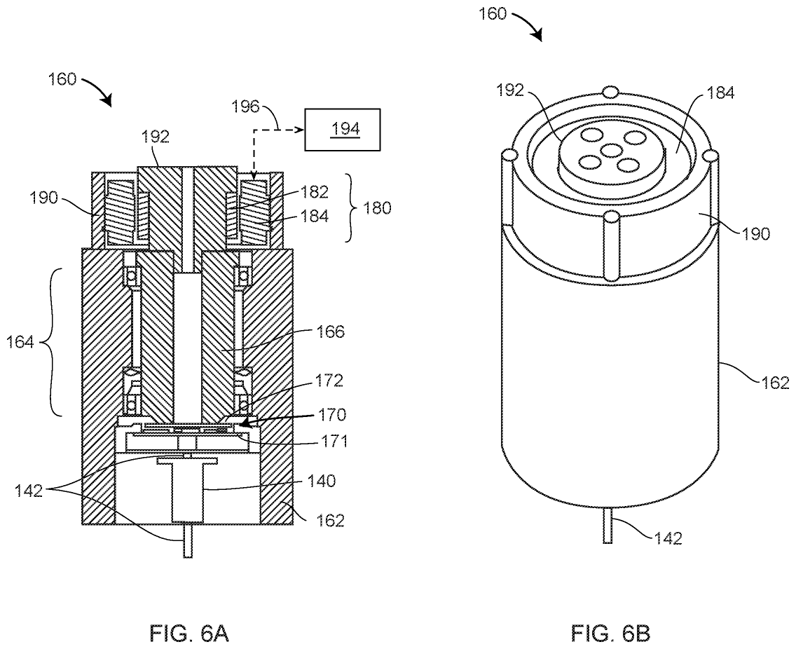

FIG. 5 is an isometric view of a lower portion of the robotic AACMM 10R. FIG. 6B is an isometric view of a motorized cartridge 160 for the first-axis assembly 100R. The motorized cartridge 160 provides a swivel rotation, which is about a vertical axis of rotation for an AACMM mounted in the usual way. FIG. 6A is a cross-sectional view of the motorized cartridge 160 taken across the central axis of the motorized cartridge 160. The motorized cartridge is located within the base 20R.

The motorized cartridge 160 includes a cartridge housing 162, a bearing assembly 164 and a shaft 166 that is rotatable within the cartridge housing 162. The cartridge housing 162 is stationary within the base 20R. In an embodiment, a position transducer assembly 170 is arranged within the cartridge housing 162 and includes at least one component connected to the shaft 166 and at least one component separate from the shaft 166. In an embodiment, the position transducer assembly 170 includes a rotary encoder that measures the angle of rotation of the shaft 166. In an embodiment, the rotary encoder includes a read-head board 171 and an optical disk 172 having marks. In some embodiments, the position transducer assembly 170 is external, rather than internal, to the cartridge housing 162. In an embodiment, cables 142 send signals through a slip ring 140.

In an embodiment, a motor 180 includes a stator 184 and a rotor 182. In an embodiment, the stator 184 includes windings that receive a current to create a magnetic field, which interact with permanent magnets of the rotor 182 to cause the rotor 182 to rotate. The rotor-and-stator subcomponent set is integrated into the motorized cartridge 160 as shown in FIG. 6A. In an embodiment, the stator 184 is fixedly attached to the motor housing 190, which is fixedly attached to the cartridge housing 162. In an embodiment, the rotor 182 is fixedly attached to an adapter 192, which is fixedly attached to the shaft 166. In an embodiment, a control unit 194 adjusts electrical current into the motor 180 as a way of controlling rotation of the rotor 182. As shown, the control unit 194 is operably connected to the integrated motor 180 by a wired or wireless communications connection 196. As explained in the discussion of FIG. 3, the motor 180 is a servo motor as well as a direct drive motor having a frameless rotor-and-stator subcomponent set.

FIG. 7A is an isometric cross-sectional view of elements internal to the motorized second-axis assembly 1200, also referred to as the motorized second-axis assembly 1200. Although the motorized second-axis assembly 1200 described herein is shown in a specific arrangement, the present description and teachings are not limiting, but rather illustrative and descriptive of a non-limiting embodiment of a motorized assembly in accordance with the present disclosure.

In an embodiment, the motorized second-axis assembly 1200 includes a rotary assembly housing 1202, an output shaft 1210, and a yoke structure 1207. The motorized rotary assembly has a first end 1204 and a second end 1206. In an embodiment, the output shaft 1210 is driven by a rotary drive assembly 1208, with the output shaft 1210 rotating on bearings 1211A, 1211B. In an embodiment, the yoke structure 1207 is coupled to the motorized cartridge 160 by a yoke 1220 shown in FIG. 7B. An exemplary method of coupling the second-axis assembly 200 to the first-axis assembly 100 with a yoke 1220 is described in FIG. 10 of commonly owned United States Patent Application No. 2018/0216923 entitled “Articulated Arm Coordinate Measuring Device,” the contents of which are incorporated by reference herein. The second end 1206 of the rotary assembly housing 1202 is coupled to the first arm segment 295. The motorized second-axis assembly 1200 enables relative movement between the structures connected at each of the ends 1204, 1206. In an embodiment, the motorized second-axis assembly 1200 is arranged to allow for both motorized operation and manual operation.

Besides providing a motorized hinge motion, the motorized second-axis assembly 1200 further provides a counterbalance for the weight of the AACMM portion past the second axis. In an embodiment, the drive assembly 1208 cooperates with a counterbalance spring 1209 to offset the weight of the arm portion past the second axis. In an embodiment, the counterbalance spring 1209 is of the sort described in the United States Patent Application No. 2018/0216923 referenced above. In another embodiment, the motorized second-axis assembly 1200 provides the counterbalance force without cooperating with a spring such as the spring counterbalance 1209.

In embodiments, the drive assembly 1208, by itself or in combination with the counterbalance spring 1209, provides enough torque to hold the elements of the AACMM fixed when an operator removes a hand from the AACMM. In other words, the drive assembly 1208, in combination with a motor control, actively counterbalances the weight of the arm portion 1206 during operation. In an embodiment, the torque applied by the motorized second-axis assembly 1200 is based at least in part on the application or removal of an external force (e.g., the operator's hand). In other words, when the operator manually positions the AACMM, the torque adjusts in response. In an embodiment, the spring is like that described in detail in United States Patent Application No. 2018/0216923, as referenced above.

In an embodiment, the motorized cartridges within the AACMM cooperate to adjust the positions and orientations of arm segments and probes within the AACMM based at least in part on angular readings from position transducers within the AACMM. In one mode of operation, arm segments are moved manually by an operator without intervention of the drive assembly 1208. In this mode of operation, the AACMM 10R behaves like a manual AACMM 10. In a related mode of operation, the AACMM 10R holds the AACMM 10 arm segments stationary in space until an operator moves the arm segments. In another related mode of operation, the operator manually moves the arm segments of the AACMM 10R, with the movements of the arm segments of the AACMM 10R recorded for playback under automated operation later. This mode of operation provides an easy way to train an AACMM to move as desired in performing an automated task. In another mode of operation, an AACMM 10R operates robotically under computer control. In an embodiment, movement in such automatic robotic operation stops when an operator places a hand on an arm segment or whenever one of the arm segments encounters an obstacle. The availability of this mode of operation ensures that the robotic AACMM 10R is safe to use collaboratively with a human operator.

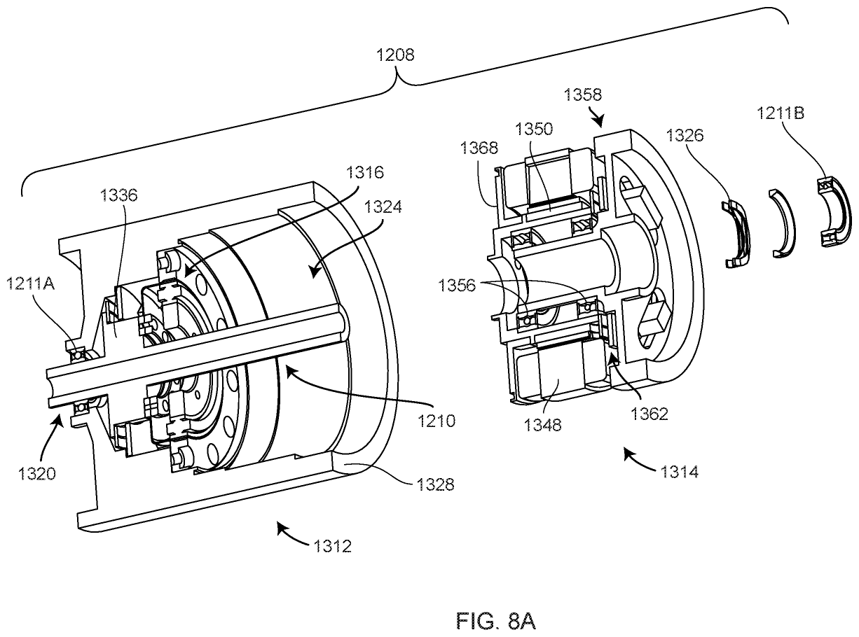

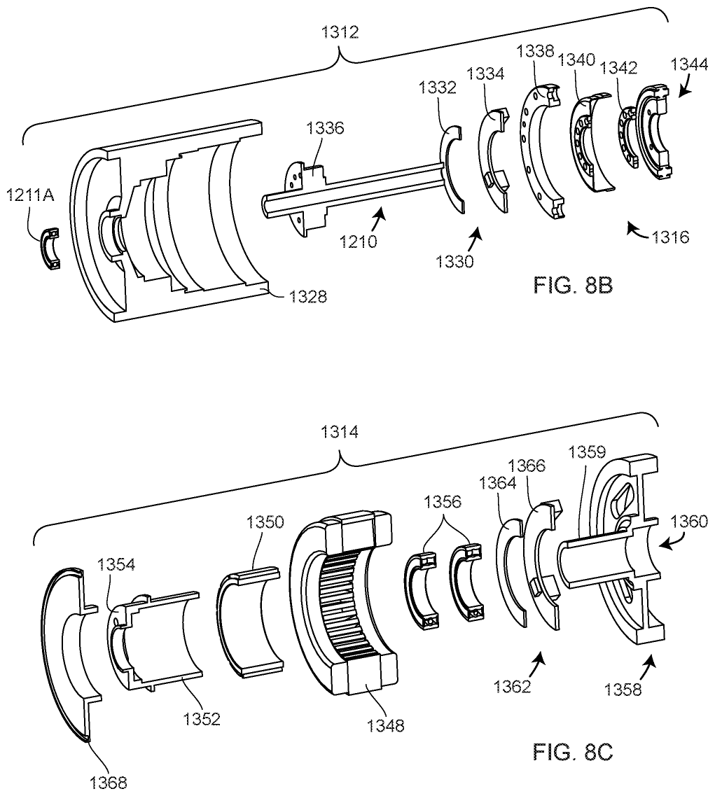

FIG. 8A is a partially exploded isometric view of the drive assembly 1208 and the output shaft 1210 according to an embodiment of the present disclosure. The drive assembly 1208 includes an output subassembly 1312 and a motor subassembly 1314. In an embodiment, the motor subassembly 1314 is operably connected to a gear assembly 1316 of the output subassembly 1312 to drive the output shaft 1210. The output shaft 1210 rides on the bearing 1211A at a first end 1320 and the bearing 1211B at the second end 1324. In an embodiment, a preload element 1326 such as a wave spring is arranged to preload one or more of the bearings 1211A, 1211B. In an embodiment, the output subassembly 1312 includes an output housing 1328 into which the output shaft 1210, the gear assembly 1316, the motor subassembly 1314, and the bearings 1211A, 1211B are installed.

FIG. 8B is an exploded isometric view of the output subassembly 1312, which includes an output encoder assembly 1330 having an encoder disk 1332 and a read head assembly 1334. In an embodiment, the encoder disk 1332 is affixed to a shaft engagement element 1336 on the output shaft 1210, causing the encoder disk 1332 to rotate with the output shaft 1210. In an embodiment, the read head assembly 1334 is rigidly affixed to the output housing 1328. The output encoder assembly 1330 measures the angle of rotation of the output shaft 1210.

The output subassembly 1312 includes the gear assembly 1316, which is operably connected to the motor subassembly 1314 to enable transfer of motion from the motor subassembly 1314 to the output shaft 1210. In an embodiment, the gear assembly 1316 includes a strain wave gear set having a circular spline 1338, a flex spline 1340, a clamping plate 1342, and a wave generator 1344. The wave generator 1344, which is fixedly connected to the flex spline 1340 by the clamping plate 1342, is driven by the motor subassembly 1314. As the wave generator 1344 is rotated, the flex spline 1340 is rotated within and relative to the circular spline 1338. As will be appreciated by those of skill in the art, the inner diameter of the circular spline 1338 includes a first set of teeth having a first number of teeth, while the outer diameter of the flex spline 1340 includes a second set of teeth having a second number of teeth different from the first number of teeth. Typically, in a strain wave generator, the second set includes one or two fewer teeth than the first set. Usually, the wave generator 1344 has an elliptical shape, which enables the wave generator 1344 to drive rotation of the flex spline. In an embodiment, the shaft engagement element 1336 is fixedly connected to the flex spline 1340, and optionally the clamping plate 1342. Consequently, when the flex spline 1340 rotates, the output shaft 1210 also rotates. The output encoder assembly 1330 monitors the angle of rotation of the output shaft 1210.

The strain wave gear set 1316 produces a gearing reduction ratio given by: reduction ratio=(flex spline teeth−circular spline teeth)/flex spline teeth. For example, if the circular spline 1338 has 202 teeth and the flex spline has 200 teeth, the reduction ratio is (200−202)/200=−0.01. The effect of this reduction ratio is discussed below in reference to FIG. 8C.

In other embodiments, the strain wave gearing mechanism is replaced by an alternative mechanism without departing from the scope of the present disclosure. For example, a cycloidal drive or cycloidal speed reducer may be used without the output subassembly 1312. In such an embodiment, an input shaft may operably connect to the motor subassembly 1314, and an eccentrically mounted bearing, arranged with a cycloidal disc and ring pins, may be employed to drive an output element operably connected to the output shaft 1210. Further, in some embodiments, the output shaft 1210 may be output element of the gear assembly 1316 when arranged as a cycloidal drive. In other embodiments, other types of gearing mechanisms are used.

FIG. 8C is an exploded isometric view of a motor subassembly 1314. In an embodiment, the motor subassembly 1314 includes a stator-rotor arrangement, with a motor stator 1348 arranged to drive a motor rotor 1350. In an embodiment, the motor rotor 1350 is connected to a motor output housing 1352, which in turn is fixedly connected at the surface 1354 to the wave generator 1344, for example, using adhesive or fasteners. As shown in FIGS. 8A, 8C, the motor output housing 1352 rotates on one or more motor bearings 1356 which are mounted on a shaft 1359 of a motor hub 1358. The motor hub 1358 includes an output shaft aperture 1360 through which the output shaft 1210 may pass. The motor subassembly 1314 further includes a shield element 1368, which is arranged to prevent fluids (e.g., grease) that might be used in the motor subassembly 1314 from entering the output subassembly 1312.

The motor subassembly 1314 includes a motor encoder assembly 1362 having an encoder disk 1364 and a read head assembly 1366. In an embodiment, the read head assembly 1366 is fixed relative to the motor hub 1358, while the encoder disk 1364 is affixed to the motor output housing 1352 and rotates with the motor rotor 1350. The purpose of the motor encoder assembly 1362 is to measure the angle of rotation of the motor rotor 1350 as a function of time.

Because of the gear assembly 1316, the output shaft 1210 rotates relatively slowly compared to the motor rotor 1350. For the example given above in which the reduction ratio was calculated to be −0.01, the rotation rate of the output shaft 1210 would be one-hundredth that of the motor rotor 1350, with the motor rotor 1350 and output shaft 1210 rotating in opposite directions. In the case of the second-axis assembly 200, the arm segment 595 and the probes or other elements attached to the arm segment 595 exert a relatively large torque on the second-axis assembly. As discussed herein above, the counterbalance spring 1209 may be used to offset some of the weight of the arm portion past the second-axis assembly 200. In addition, the gear assembly with its reduction ratio less than 1.0 provides a further means of obtaining relatively high torque with a relatively small motor that generates little heat and uses little power.

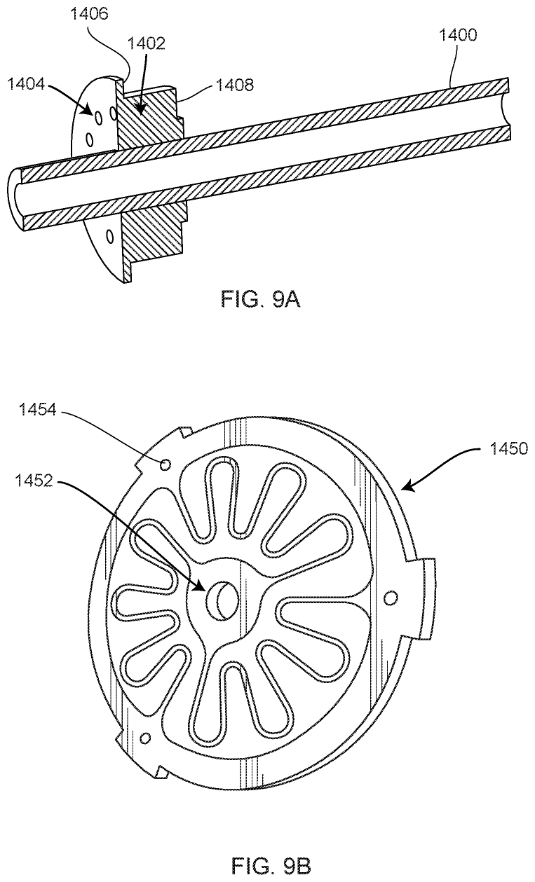

FIG. 9A is an exploded isometric view of a shaft engagement element 1402 according to an embodiment of the present disclosure. Unlike the shaft engagement element of FIGS. 8A, 8B, the shaft engagement element 1402 is a separate element from the output shaft 1400. The shaft engagement element 1402 may be press fit onto the output shaft 1400 or affixed to the shaft with adhesive or fasteners. In an embodiment, the shaft engagement element 1402 or the output shaft 1400, or both, are formed from an elastic material. Such an elastic material, when used properly in a control loop, provides many advantages in a robotic arm 10R. This is discussed further herein below, especially in reference to the control system 1600 of FIG. 10A. In an embodiment, the shaft engagement element 1402 includes a plurality of apertures 1404 to enable fixed connection between the shaft engagement element 1402 and the flex spline 1340. In an embodiment, the shaft engagement element 1402 includes an encoder disk engagement surface 1406 configured to receive the encoder disk 1364 and a gear engagement surface 1408 configured to receive the flex spline 1340.

FIG. 9B shows an embodiment of an alternative elastic element 1450. The elastic element 1450 includes a shaft aperture 1452 and mounting holes 1454. In an embodiment, a shaft such as the output shaft 1400 is passes through and is affixed to the shaft aperture. In an embodiment, the mounting holes provide a way to affix the alternative elastic element 1450 to a flex spline such as the flex spline 1340. Unlike the output shaft 1400 and shaft engagement element 1402, the elastic element 1450 relies mainly on structural elasticity rather than material elasticity to obtain the desired elastic effect. In general, a combination of structural and material elasticity may be used to obtain a desired elastic effect.

FIG. 10A is a block diagram of a torque-feedback control system 1600 according to an embodiment of the present disclosure. In an embodiment, an operation control block 1602 sends a signal indicative of a desired position and/or velocity to a motion control block 1604, which in turn sends a signal to a motor 1606. The motor 1606, which rotates or otherwise moves in response to the signal from the motion control block 1604, sends a signal to control a gear train 1608. The gear train 1608 transfers force to an elastic element 1610, which in turn drives a load 1611 such as an output shaft.

In an embodiment, part of the signal from the motion control block 1604 to the motor is measured by a current sensor 1612, which provides a signal indicative of the resulting motor torque τₘ to the operation control block 1602 and the motion control block 1604. A first angular sensor 1614 measures the angular position θ of the motor 1606, thereafter providing a signal indicative of the angle θ to the motion control block 1604 and to a torque model block 1616. A second angular sensor 1618 measures an angle α of the elastic element 1610, providing this angle to the torque model block 1616 and to the operation control block 1602.

In a system having a load that provides little resistance to force applied by the gear train 1608, the elastic element 1610 barely deforms in response to the applied load. In other words, when the desired torque of the gear train 1608 is small, deformation of the elastic element is also small. In this case, the ratio in the change of angles measured by the second angular sensor 1618 to the change of angles measured first angular sensor 1614 is nearly equal to the mechanical advantage (ratio) provided by the gear train 1608. On the other hand, in a system having a load that provides high resistance to force applied by the gear train 1608, the elastic element 1610 deforms by a relatively large amount. For example, in this case, a relatively large “spring energy” is stored in elastic elements, which might be, for example, the output shaft 1400, the shaft engagement element 1402, or the alternative elastic element 1450. For the case of high load resistance, the additional deformation in the elastic element results in a departure in the angles measured by angular sensors 1614, 1618 from that predicted by the mechanical advantage of the gear train 1608. The torque model block 1616 provides an estimate of the load torque τ_{L} based on the angles measured by the angular sensor 1 and the angular sensor 2. In most cases, the torque model block 1616 is based on experimental results in which changes in angles of the first angular sensor 1614 and the second angular sensor 1618 are compared for different load resistances (e.g., different load torques). In an embodiment, the results of such experiments may be stored in a look-up table or an equation accessed by a processor operably coupled to the torque model block 1616. In another embodiment, the torque model block 1616 is implemented with analog circuitry rather than digital circuitry.

The use of the elastic element 1610 enables an AACMM 10R to respond as needed for the range of different circumstances encountered in practice. For example, in ordinary robotic operation, the arm segments 295, 595 are expected to remain stationary while a measurement is being made with tactile-probe assembly 900 or with another sensor such as a scanner, as discussed further herein below. It is also important that appropriate current is provided to generate torque to move the arm segments 295, 595 and the tactile-probe assembly 900 (or other probe assembly) to the desired locations. If an obstacle is encountered during movement of the arm segments 295, 595, the AACMM should reduce the applied current to ensure that no injury is caused to a human operator. Also, it is highly desirable that an operator be able to train the robotic AACMM 10R to move from location to location (e.g. along a prescribed path) by moving the arm segments to those locations as desired for a measurement task.

To provide an appropriate robotic movement without assistance of an operator, an appropriate amount of current is applied by the motion control block 1604 to the motor 1606. For the case of the motorized second-axis assembly 1200, the motor 1606 corresponds to the motor stator 1348 and the motor rotor 1350, as shown in FIG. 8C. Furthermore, the appropriate amount of current sent to the motor 1606 is determined partly based on readings of the first angular sensor 1614 and the second angular sensor 1618. For the motorized second-axis assembly 1200, the first angular sensor 1614 corresponds to the motor encoder assembly 1362 having an encoder disk 1364 and a read head assembly 1366. The motor encoder assembly 1362 measures the angle of rotation of the motor rotor 1350 as a function of time. The second angular sensor 1618 corresponds to the output encoder assembly 1330 having an encoder disk 1332 and a read head assembly 1334. The output encoder assembly 1330 measures the angle of rotation of the output shaft 1210, which corresponds to the load 1611 in FIG. 10A. Although the control system 1600 described herein is shown in a specific arrangement, the present description and teachings are not limiting, but rather illustrative and descriptive of a non-limiting embodiment of a control system in accordance with the present disclosure.

The behavior of the control system 1600 of FIG. 10A was described in reference to the motorized second-axis assembly 1200, which provides a hinge motion for the AACMM 10R at the second joint. This method could equally well be used for other the fourth-axis assembly 400 and the sixth-axis assembly, which also provide hinge motion in the embodiment of FIG. 1C.

The method of control system 1600 may also be used to obtain an elastic action in a motorized assembly producing a swivel action. In other words, an elastic element may be incorporated into the first-, third-, fifth-, and seventh-axis assemblies, hereafter referred to as swivel assemblies. FIGS. 10B, 10C, 10D, 10E, 10F, 10G, 10H, 10J, 10K now describe elements of motorized and geared swivel assemblies according to embodiments of the present disclosure.

FIG. 10B is an isometric cross-sectional view of an extended motorized swivel assembly 1700. having a motor/gear subassembly 1710, an output subassembly 1750, and an arm segment 1780. In an embodiment, the output subassembly 1750 is connected to another axis assembly, for example, one that provides a hinge rotation of another segment of an AACMM.

FIG. 10C is an enlarged view of the motor/gear subassembly 1710. In an embodiment, the motor/gear subassembly 1710 includes a motor hub 1758, a motor encoder assembly 1762, a motor subassembly 1746, a gear assembly 1716, a motor housing 1728, a portion of an extended housing 1782, a portion of an elastic shaft 1784, a carrier 1785, a pair of motor bearings 1756, and a shaft bearing 1711B. The arm segment 1780 includes the extended housing 1782 and the elastic shaft 1784. The motor subassembly 1746 includes a stator 1748, which may have windings, and a rotor 1749, which may have permanent magnets. In an embodiment, the motor hub 1758 includes a hub shaft 1759 on which a pair of motor bearings 1756 are mounted to support the rotating rotor 1749, which is fixedly coupled to a wave generator 1744 by a coupling tube 1743. In an embodiment, the gear assembly 1716 includes a strain wave gear set having a circular spline 1738, a flex spline 1740, a clamping plate 1742, and a wave generator 1744. The wave generator 1744, which is fixedly connected to the flex spline 1740 by the clamping plate 1742, is driven by the motor subassembly 1746. As the wave generator 1744 is rotated, the flex spline 1740 is rotated within and relative to the circular spline 1738. As will be appreciated by those of skill in the art, the inner diameter of the circular spline 1738 includes a first set of teeth having a first number of teeth, while the outer diameter of the flex spline 1340 includes a second set of teeth having a second number of teeth different from the first number of teeth. Typically, in a strain wave generator, the second set includes one or two fewer teeth than the first set. Usually the wave generator 1744 has an elliptical shape, which enables the wave generator 1744 to drive rotation of the flex spline. The relative number of flex spline teeth and circular spline teeth may be used to calculate the gear reduction ratio, as explained herein above in reference to FIGS. 8B, 8C. The motor housing 1728 is fixedly attached to the extended housing 1782. The elastic shaft 1784 is fixedly attached to the carrier 1785, which is coupled to the inner race of the shaft bearing 1711B. In an embodiment, the motor encoder assembly 1762 includes a read-head board 1766 and an encoder disk 1764.

FIG. 10D is an enlarged view of the output subassembly 1750, which includes an output frame 1786, a portion of the extended housing 1782, a portion of the elastic shaft 1784, a shaft bearing 1711A, and an output encoder assembly 1730. The elastic shaft 1784 is fixedly coupled to the output frame 1786 and rotates relative to extended housing 1782 on shaft bearings 1711A, 1711B. In an embodiment, the output encoder assembly 1730 includes a read-head board 1732 and an encoder disk 1734.

FIG. 10E is a cross-sectional isometric view of a motorized cartridge 1800 that produces swivel rotation and fits inside a receptacle such as the receptacle 304R within a cartridge adapter such as the cartridge adapter 302R. The motorized cartridge 1800 includes a motor/gear subassembly 1810 and an output subassembly 1850.

FIG. 10F is an exploded view of the motor/gear subassembly 1810 and the output subassembly 1850. In an embodiment, the motor/gear subassembly 1810 includes a motor hub 1858, a motor encoder assembly 1862, a motor subassembly 1846, a gear assembly 1816, a motor housing 1828, an extended housing 1882, an elastic flexure 1884, a pair of motor bearings 1856, and a shaft bearing 1811B. The motor subassembly 1846 includes a stator 1848, which may have windings, and a rotor 1849, which may have permanent magnets. In an embodiment, the motor hub 1858 includes a hub shaft 1859 on which a pair of motor bearings 1856 are mounted to support the rotating rotor 1849, which is fixedly coupled to a wave generator 1844 by a coupling tube 1843. In an embodiment, the gear assembly 1816 includes a strain wave gear set having a circular spline 1838, a flex spline 1840, a clamping plate 1842, and the wave generator 1844. The wave generator 1844, which is fixedly connected to the flex spline 1840 by the clamping plate 1842, is driven by the motor subassembly 1846. As the wave generator 1844 is rotated, the flex spline 1840 is rotated within and relative to the circular spline 1838. As will be appreciated by those of skill in the art, the inner diameter of the circular spline 1838 includes a first set of teeth having a first number of teeth, while the outer diameter of the flex spline 1840 includes a second set of teeth having a second number of teeth different from the first number of teeth. Typically, in a strain wave generator, the second set includes one or two fewer teeth than the first set. Usually the wave generator 1844 has an elliptical shape, which enables the wave generator 1844 to drive rotation of the flex spline. The relative number of flex spline teeth and circular spline teeth may be used to calculate the gear reduction ratio, as explained herein above in reference to FIGS. 8B, 8C. A ring 1885 is fixedly attached to the flex spline 1840 as well as to an inner portion of the elastic flexure 1884. The outside of the ring 1885 is fixedly attached to an output frame 1886. The inner race of the shaft bearings 1811A, 1811B are fixedly attached to the output frame 1886, while the outer race of the shaft bearings 1811A, 1811B are rigidly affixed to the extended housing 1882. In an embodiment, a wave spring 1881 applies a preload force to the bearing 1811B. In an embodiment, the motor encoder assembly 1862 includes a read-head board 1866 and an encoder disk 1864. In an embodiment, the output encoder assembly 1830 includes a read-head board 1832 and an encoder disk 1834.

FIGS. 10G, 10H, 10J are front, side, and isometric views of the output subassembly 1850. FIG. 10K is a front view of the elastic flexure 1884 shown in a larger scale than in FIGS. 10G, 10J. As shown in FIGS. 10E, 10F, the ring 1885 is fixedly attached to the flex spline 1840 as well as to an inner portion of the elastic flexure 1884. In this way, the elastic flexure 1884 serves the function of the elastic element 1610 in the control system 1600 of FIG. 10A. The elastic flexure 1884 is similar in some respects to the elastic element 1450, but the elastic element 1450 is attached to a solid central shaft, while the elastic flexure 1884 provides an opening through the ring 1885, which may accommodate passing wires, for example.

The block diagram of the torque-feedback control system 1600 applies equally well to the extended motorized swivel assembly 1700 or the motorized cartridge 1800 as to the motorized second-axis assembly 1200, which provides hinge rotation. The extended motorized swivel assembly 1700, the motorized cartridge 1800, and the motorized second-axis assembly 1200 share in common the following elements: a motor subassembly, a gear subassembly, two sets of two paired bearings (one pair for the motor and one pair for the output shaft), two encoder assemblies (one for the motor and one for the output shaft), and an elastic element. For the extended motorized swivel assembly 1700, the elastic element 1784 is an inner tubular element that rotates within the extended housing 1782. For the motorized cartridge 1800, the elastic element is the elastic flexure 1884. Spring type energy is built up within the elastic elements 1782, 1784 as torque is applied between the ends of the motorized swivel assembly. The control system 1600 determines this torque based on readings of the two rotary encoders, the current applied to the motor assembly, and the reduction ratio of the gear assembly as explained herein above in reference to FIG. 10A. The extended motorized swivel assembly 1700 is an extended structure, while in contrast the motorized cartridge 1800 and the motorized second-axis assembly 1200 are localized structures.

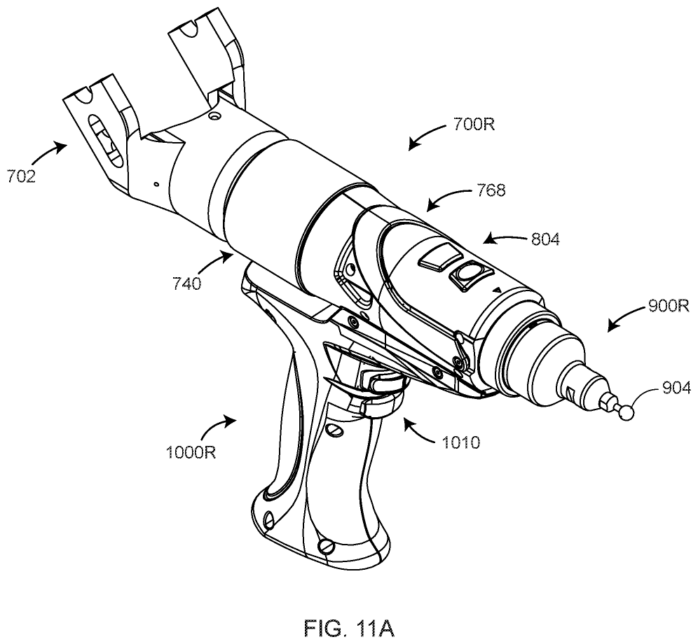

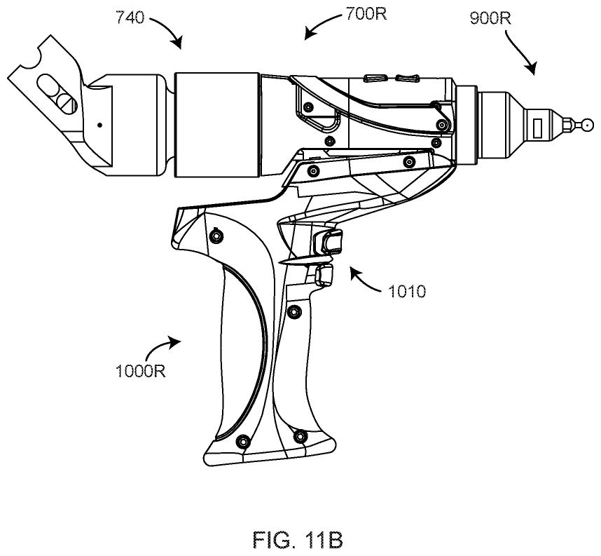

FIG. 11A is an isometric view of the seventh-axis assembly 700R, handle 1000R, and tactile-probe assembly 900R. In an embodiment, the seventh-axis assembly 700R includes a seventh-axis yoke 702, a probe latch 768, and upper end-effector buttons 804. In an embodiment, the seventh-axis yoke 702 attaches at one end to the sixth-axis shaft 618 (FIG. 4B) of the sixth-axis assembly 600R. In an embodiment, the seventh-axis assembly 700R includes a cartridge having elements like those shown in FIG. 3 such as bearings, rotary encoder elements, stator and rotor motor components, and a slip ring. In an embodiment, the cartridge in the seventh-axis assembly 700R produces a swivel rotation for the seventh-axis assembly 700R. The handle 1000R includes button actuators 1010. The tactile-probe assembly 900R include a probe tip 904. The seventh-axis assembly 700R further includes upper end-effector buttons 804. FIG. 11B is a side view of the handle 1000R being attached to the seventh-axis assembly 700R. In an embodiment, a clutch mechanism 740 is used to attach and detach the handle 1000R.

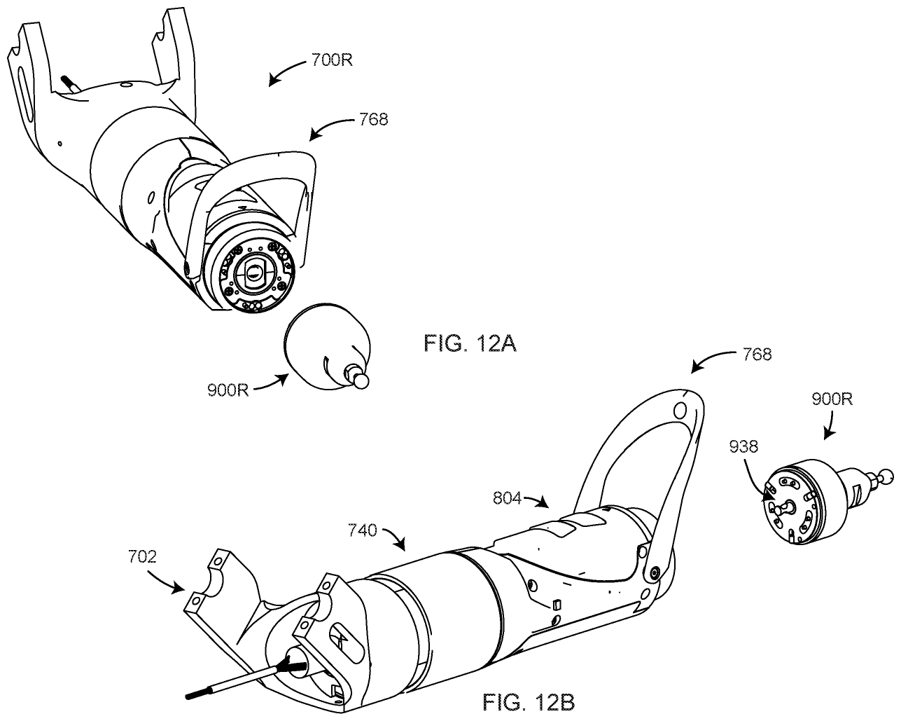

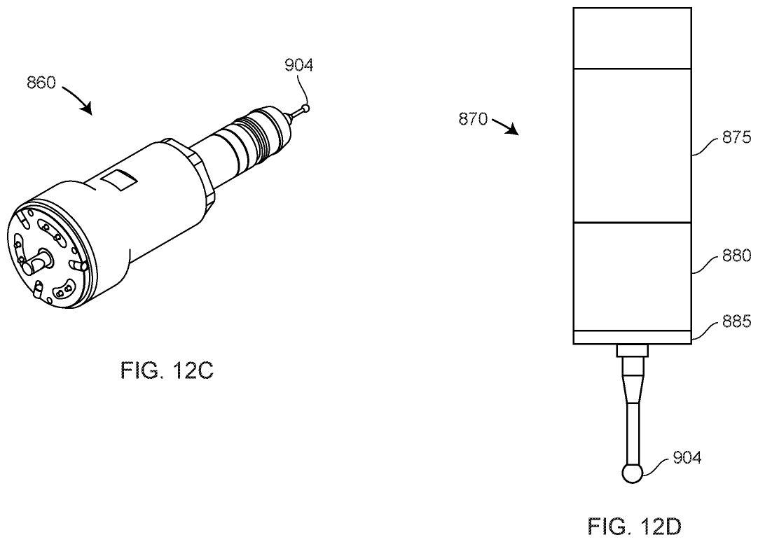

FIGS. 12A, 12B are first and second views, respectively, of the tactile-probe assembly 900R detached from the seventh-axis assembly 700R. FIG. 12A shows the mechanical alignment/latching elements and electrical elements to which the tactile-probe assembly 900R attaches on the seventh-axis assembly. FIG. 12B shows the corresponding mechanical alignment/latching elements and electrical elements of the tactile-probe assembly 900R. The tactile-probe assembly 900R includes a pull stud 938 that inserts into the seventh-axis assembly 700R and is locked in place by the probe latch 768.

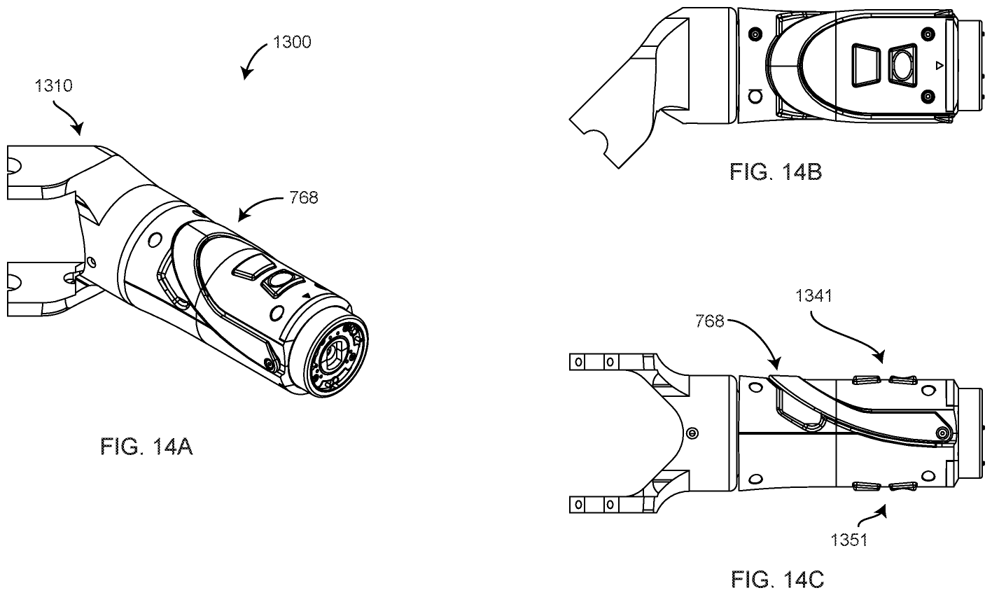

FIG. 12C is an isometric view of a touch-trigger probe assembly 860. The touch-trigger probe assembly 860 inserts into the seventh-axis assembly 700R in the same manner as the tactile-probe assembly 900R, which is also referred to as a hard-probe assembly 900R, as illustrated in FIGS. 12A, 12B. Also like the tactile-probe assembly 900R, the touch-trigger probe assembly 860 may be inserted into the end-effector assembly 1300 shown in FIGS. 14A, 14B, 14C.

When the hard-probe assembly 900R is in use, the base processor electronics generates a capture signal at regular intervals, which causes the angular encoders to return angular readings to the base processor electronics, thereby enabling calculation of a position of a probe tip 904 (FIG. 11A) on the hard-probe assembly 900R. In contrast, a touch-trigger probe assembly 860 triggers a reading when a designated force is applied to the probe tip 904. Hence angular readings are taken in response to the trigger signal sent from the touch-trigger probe assembly 860.

In an embodiment, the probing assembly includes a scanning probe head 870 illustrated in FIG. 2D. In an embodiment, the scanning probe head 870 includes a transducer subassembly 875, a kinematic-mount subassembly 880, and an adaptor-stylus subassembly 885. In an embodiment, the scanning probe head 870 includes components available from Renishaw plc located at Wotton-under-Edge in the United Kingdom. In an embodiment, the transducer subassembly 875 is a Renishaw model SP25M and the kinematic-mount subassembly 880 is a Renishaw Model SM25-1. In an embodiment, the transducer subassembly 875 includes a pair of infrared emitting diodes (IREDs), which send light onto a pair of concave mirrors located in the kinematic-mount subassembly 880, which focus the light onto a pair of position sensitive detectors (PSDs) in the transducer subassembly. The transducer subassembly further includes a collection of springs that accommodate movement of the probe tip 904, which is rigidly affixed to the adaptor-stylus subassembly 885. The extent and direction of movement of the probe tip 904 is determined based on the relative displacement of the beams of the pair of PSDs and on the length of the stylus in the adaptor-stylus subassembly 885.

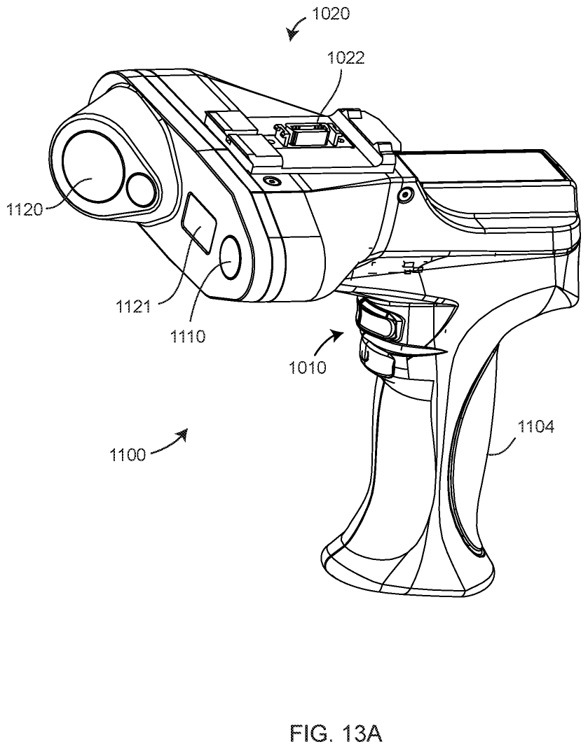

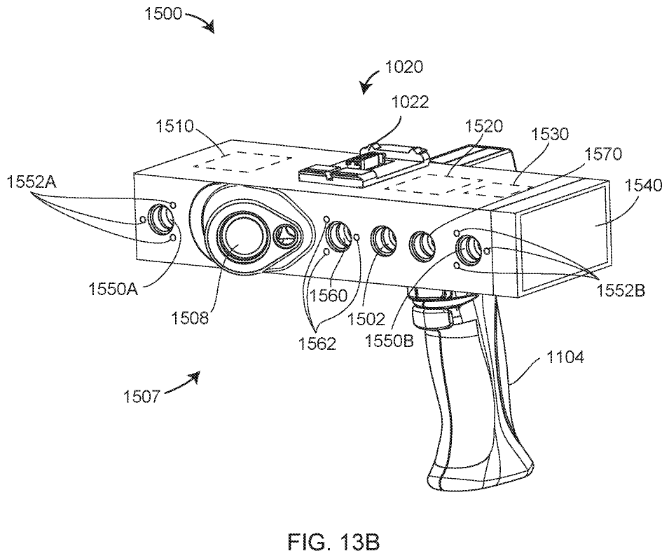

FIG. 13A is an isometric view of a laser line probe (LLP) 1100, also referred to as a line scanner, which is an example of an accessory that may be attached to the seventh-axis assembly 700 in place of the handle 1000R. In an embodiment, the LLP 1100 includes an interface 1020 that provides mechanical and electrical connection to the seventh-axis assembly 700. In an embodiment, the interface 1020 includes a handle-to-arm connector 1022. In an embodiment, the LLP 1100 includes a projector 1110 and a camera 1120 separated by a baseline distance, the LLP having a processor that perform triangulation calculations to determine 3D coordinates of points illuminated by a line of laser light or a pattern of light, which might be laser light or another type of light such as light from a superluminescent diode of light emitting diode. In an embodiment, the LLP 1100 includes an additional two-dimensional (2D) camera 1121, which may be used for augmented reality (AR) or for other purposes. In an embodiment, the LLP 1100 alternatives between dimmer and brighter beams of light, combining the beams as used to obtain high dynamic range (HDR) in the captured 3D image. With such a system, it is possible to obtain 3D measurements having relatively high accuracy over an object having both regions of high reflectivity and regions of low reflectivity. In other embodiments, the HDR system does not alternative between dimmer and brighter beams but instead alternatives between relatively long and relatively short exposure/integration times. An exemplary HDR LLP is U.S. Pat. No. 9,500,469 to Atwell et al., the contents of which are incorporated by reference herein. In an embodiment, the LLP 1100 is mounted on a handle 1104.

In an embodiment, an LLP 1120 is capable of measuring 3D coordinates of an object, even in the HDR mode described herein above, and in addition to capture color of the object. The result is a relatively accurate 3D color image. An exemplary color LLP is U.S. Pat. No. 9,658,061, the contents of which are incorporated by reference herein.

FIG. 13B is an isometric view of a 3D measuring device 1500 that may be attached to the seventh-axis assembly 700R in place of the handle 1000R. In an embodiment, the 3D measuring device 1500 includes an interface 1020 that provides mechanical and electrical connection to the seventh-axis assembly 700R. In an embodiment, the interface 1020 includes the handle-to-arm connector 1022.

In an embodiment, measuring device 1500 includes a scanner 1507 having a projector 1502 and a camera 1508. The projector 1502 may project a point of light, a line of light, or a pattern of light that covers an area. The principles of operation of a line scanner and an area scanner are discussed herein above. In some cases, two or more cameras may be used with either type of scanner. In an embodiment, the projector 1502 may include a digital micromirror device (DMD) capable of projecting any type of pattern. For example, a DMD can project any desired structured pattern of light over an area. It may project a line of light at any angle, and it may sweep the line of light. The DMD may alternatively sweep a spot of light. Sweeping a line or a spot of light is a useful technique for reducing or eliminating multipath interference, which such interference is observed to have occurred or is expected to have occurred based on geometry of the object being scanned.

In an embodiment, the cameras 1550A, 1550B form a stereo camera pair. In an embodiment, the cameras 1550A, 1550B determine 3D coordinates of targets within a frame of reference of the 3D measuring device 1500. In an embodiment, cameras 1550A, 1550B determine the 3D coordinates of reflective targets within their fields-of-view (FOV). The targets may be located on or proximate an object under test. In an embodiment, the reflective targets are illuminated by light from light sources 1552A, 1552B. In an embodiment, the light sources 1552A, 1552B are light-emitting diodes (LEDs). In another embodiment, the cameras 1550A, 1550B determine the 3D coordinates of light sources such as LEDs on or proximate an object under test. In another embodiment, the cameras 1550A, 1550B determine the 3D coordinates of light marks, such as spots of light, projected onto the object by an external projector fixed with respect to the object. In the exemplary embodiment, the light sources 1552A, 1552B are disposed about the periphery of the cameras 1550A, 1550B.

In an embodiment, the light sources 1552A, 1552B are configured to project light at a wavelength different than to which the scanner camera 1508 is sensitive. For example, the camera 1508 may be configured to respond to blue light at 450 nm, with the optics coated to block light outside a band of blue wavelengths. In this case, the light sources 1552A, 1552B may be configured to emit a different wavelength, for example, a near infrared wavelength of 800 nm. In this case, the cameras 1550A, 1550B may be coated to reduce or eliminate light from the blue wavelengths emitted by the scanner projector. This arrangement of wavelengths may be advantageous if the scanner 1507 operates synchronously with the stereo camera pair 1550A, 1550B. In other cases, the cameras 1550A, 1550B may be configured to respond to the wavelengths emitted by the projector 1502. This might be advantageous, for example, to enable the stereo camera pair to independently determine the 3D coordinates of a line or pattern of light emitted by the projector 510.

In an embodiment, the 3D coordinates of widely distributed markers on or proximate an object are determined in a global frame of reference using a photogrammetry. In an embodiment, the photogrammetry system includes a camera and a calibrated scale bar, with the camera used to measure the markers and the calibrated scale bar in a plurality of digital 2D images. By processing the multiple 2D images, the 3D coordinates of the collection of markers may be determined in a common (global) frame of reference. Such a method may be advantageous when measuring a large object, especially when using relatively few markers.

In another embodiment, a single camera 1550A or 1550B is used to captures 2D images of markers. If the camera 1550A or 1550B has a relatively wide FOV, the markers in the plurality of captured images may provide continuity to the scanner system in registering the plurality of 3D scanner coordinates collected in successive frames.

In an embodiment, the 3D measuring device 1500 further includes a color camera 1560. The colors captured by the color camera 1560 may be used to add color to a 3D image captured by the scanner 1507. Such coloration is sometimes referred to as adding texture to a 3D image because it may reveal such aspects of surface roughness, surface reflectance properties (such as shininess or transparency), and shadows. In an embodiment, light sources 1562 may be used to increase the light applied to an object or to apply particular wavelengths of light. For example, infrared light may be projected from the light sources 1562 to enable a map of object temperature to be overlaid on the captured 3D image. In other embodiments, the light sources 1562 may project over a broad spectrum to provide a more desirable lighting than would be provided by artificial light such as that provided by fluorescent lights, which may produce a green hue. In the exemplary embodiment, the light sources 1562 are disposed about the periphery of the color camera 1560.

In an embodiment, the 3D measuring device 1500 further includes a battery 1510, a processor 1520, and a wireless communication system 1530. In an embodiment, a wireless communication system 1530 includes an antenna and wireless electronics, which might for example be based on IEEE 802.3 (Ethernet), IEEE 802.11 (Wi-Fi) or IEEE 802.15 (Bluetooth). In a further embodiment, the 3D measuring device 1500 includes a display 1540, which may be a touch-screen display. The display may show test results or allow user entry of settings. In an embodiment, the 3D measuring device 1500 includes a distance meter 1570, which includes a transmitter and a receiver. In the embodiment illustrated in FIG. 13B, the transmitter and receiver are coincident, but separate ports for a transmitter and receiver are possible. In embodiments, the distance meter 1570 may be any of an interferometer, an absolute distance meter (ADM) device, a focusing meter, or another type of non-contact distance measurement device. A distance meter like 1570 used with an AACMM is described in U.S. Pat. No. 8,677,643, the contents of which are incorporated by reference herein. In an embodiment, the 3D measuring device 1500 includes a handle 1104.

The seventh-axis assembly 700R is useful when it is advantageous to rotate an accessory such as the LLP 1100 about an axis aligned with the seventh-axis assembly 700R. In the case of the LLP 1100, which in an embodiment emits a line of laser light, it is useful to be able to rotate the LLP to different directions to allow an object under test to be scanned in several different directions. For the case of a tactile-probe assembly 900R illustrated in FIGS. 12A, 12B, the tactile-probe assembly 900R does not rotate along with seventh-axis assembly 700R. In other words, in an embodiment, even as an outer part of the seventh-axis assembly 700R rotates, the tactile-probe assembly 900R does not rotate. Hence, if a robotic arm 10R is planned for use with a tactile-probe or seventh-axis assembly 700R and without an accessory such as the LLP 1100, the seventh-axis assembly may be left off the robotic AACMM 10R without any loss of performance.

In an embodiment, a robotic AACMM is a six-axis AACMM that includes a first-axis assembly 100R, a second-axis assembly 200R, a third-axis assembly 300R, a fourth-axis assembly 400R, a fifth-axis assembly 500R, and a sixth-axis assembly 600R, but not a seventh-axis assembly 700R. A six-axis AACMM is advantageous whenever the main use of the AACMM is to measure with a tactile-probe assembly 900R. In an embodiment, the seventh-axis assembly 700R is replaced with end-effector assembly 1300 to obtain a six-axis AACMM. As illustrated in FIGS. 14A, 14B, 14C, exterior elements of the end-effector assembly 1300 include an end-effector yoke 1310, a probe latch 768, upper end-effector buttons 1341, and lower end-effector buttons 1351.

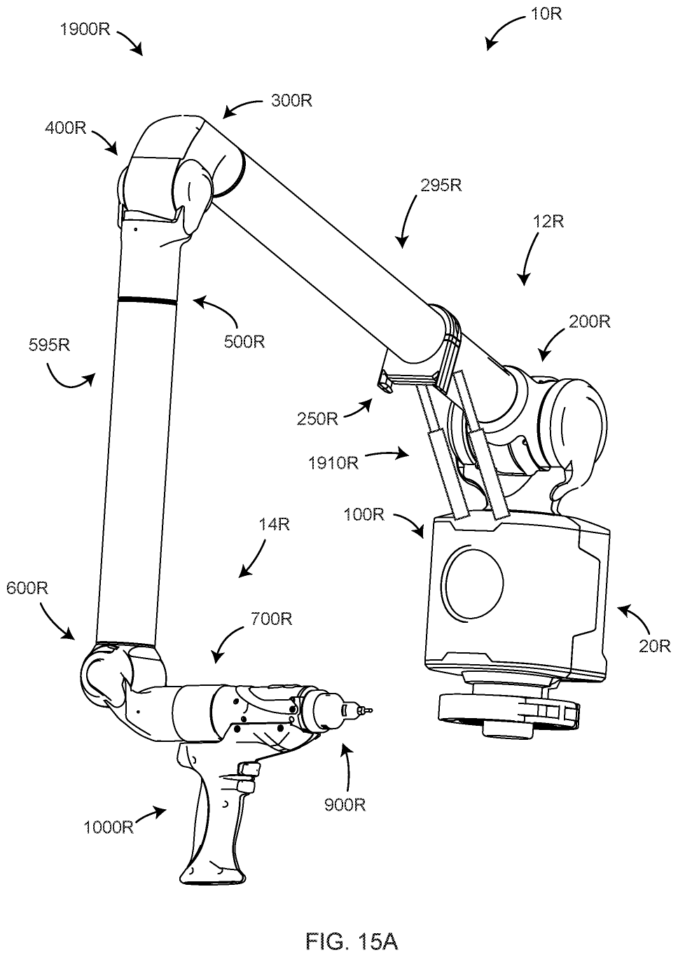

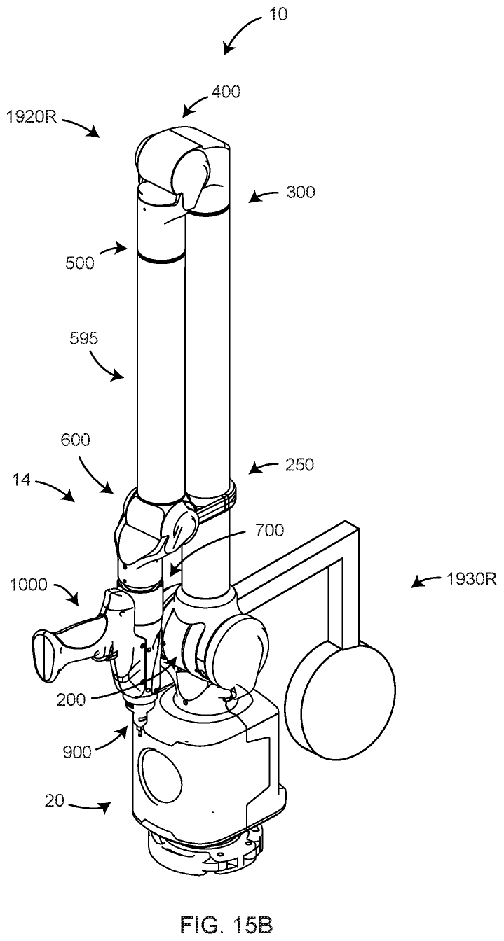

In an embodiment described herein above, especially in reference to FIG. 7A, a counterbalance spring 1209 is used to provide a counterbalance to the force of gravity of the arm segments 295R, 595R and other components hanging off the second-axis assembly 200R. The counterbalance spring 1209 provides a counterbalancing torque or force that reduces the amount of desired torque of the motorized second axis-assembly 1200. Two alternative embodiments that likewise provide a counterbalance to the force of gravity are shown in FIGS. 15A, 15B. FIG. 15A shows an embodiment of a robotic AACMM 1900R in which the counterbalancing torque/force is provided by hydraulic cylinders 1910R. The hydraulic cylinders 1910R contain compressed fluid that exerts an upward force on the first arm segment 295. FIG. 15B shows an embodiment of a robotic AACMM 1920R in which the counterbalancing torque/force is provided by a counterbalancing weight 1930R.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not limited by the foregoing description but only limited by the scope of the appended claims.

1. A motorized articulated arm coordinate measuring machine (AACMM) comprising:
a base;
an arm portion having opposing first end and second end, the arm portion being rotationally coupled to the base, the arm portion including a plurality of connected arm segments, each arm segment including at least one position transducer for producing a position signal, each arm segment further including a motorized assembly operable to rotate about an axis, the motorized assembly including either a motorized cartridge or an extended motorized assembly;
a measurement probe coupled to the first end; and
an electronic circuit operable to receive the position signal from the at least one position transducer and provide data corresponding to a position of the measurement probe, the electronic circuit further operable to direct movement the measurement probe.

2. The motorized AAACMM of claim 1, wherein at least one motorized assembly includes a motor having a stator and a rotor.

3. The motorized AACMM of claim 2, wherein the at least one motorized assembly further includes an elastic element.

4. The motorized AACMM of claim 3, wherein the at least one motorized assembly further includes a gear assembly.

5. The motorized AACMM of claim 4, wherein the at least one motorized assembly further includes a first rotary encoder operable to measure first angles and a second rotary encoder operable to measure second angles.

6. The motorized AACMM of claim 5, wherein the at least one motorized assembly further includes a first pair of bearings and a second pair of bearings.

7. The motorized AACMM of claim 6, wherein the at least one motorized assembly is affixed to one of the plurality of connected arm segments, the at least one motorized cartridge causing either a swivel rotation or a hinge rotation of the arm segment.

8. The motorized AACMM of claim 7, wherein motion of the one of the plurality of connected arm segments is determined at least in part by a control system that adjusts the motor motion based at least in part on the first angles measured by the first rotary encoder and the second angles measured by the second rotary encoder.

9. The motorized AACMM of claim 8, wherein the second angles are angles of rotation of the elastic element, the elastic element being driven by the gear assembly.

10. The motorized AACMM of claim 9, wherein motion of the arm segments is responsive to force applied to the arm segments.

11. The motorized AACMM of claim 10, wherein, in a first mode, an operator may manually move the arm segments to desired positions.

12. The motorized AACMM of claim 11, wherein the arm segments remain stationary in their current positions in absence of the force applied by the operator or a command given by a processor to the control system.

13. The motorized AACMM of claim 12, wherein, in a mode of operation of the motorized AACMM, the operator trains the motorized AACMM to move the arm segments in a prescribed path by moving the arm segments in the prescribed path.

14. The motorized AACMM of claim 13, wherein, in response to an instruction given by the processor, the motorized AACMM moves the arm segments in the prescribed path and measures three-dimensional (3D) coordinates of a point on an object.

15. The motorized AACMM of claim 14, wherein the AACMM further measures three-dimensional (3D) coordinates of the point on an object in response to a command given by the processor.

16. The motorized AACMM of claim 1, wherein the measurement probe is selected from a group consisting of hard-probe, a touch-trigger probe, and a scanning probe.

17. The motorized AACMM of claim 1, wherein the measurement probe includes a line scanner.

18. The motorized AACMM of claim 1, wherein the measurement probe includes a stereo camera.

19. The motorized AACMM of claim 1, wherein the measurement probe includes a distance meter.

20. The motorized AACMM of claim 17, wherein the line scanner includes a high dynamic range (HDR) mode.

21. The motorized AACMM of claim 1, wherein the line scanner measures object color as well as three-dimensional (3D) coordinates.

22. The motorized AACMM of claim 1, wherein the measurement probe is a structured light scanner.

23. The motorized AACMM of claim 10, wherein the control system stops movement of the arm segments in response to the force that exceeds a specified desired limit.

24. The motorized AACMM of claim 7, wherein the motorized assembly is the motorized cartridge, the motorized cartridge being affixed within a receptacle, the receptacle being coupled to the one of the plurality of connected arm segments.

25. The motorized AACMM of claim 1, wherein each of the plurality of connected arm segments is driven in a swivel rotation or a hinge rotation by the motorized cartridge or the extended motorized assembly, each motorized cartridge or motorized assembly including a motor, a rotary encoder, and a pair of bearings.

26. The motorized AACMM of claim 23, wherein the at least one motorized cartridge is coupled to a counterbalance spring.

27. The motorized AACMM of claim 23, wherein the action of at least one motorized cartridge receives a counterbalancing torque from a counterbalancing element selected from a group consisting of: a hydraulic cylinder and a counterbalancing weight.

28. The motorized AACMM of claim 6, wherein the motorized assembly is the extended motorized assembly, the extended motorized assembly further including one of the arm segments.
